(19) United States
(12) Patent Application Publication
(10) Pub. No.: US 2023/0104886 A1
(43) Pub. Date: Apr. 6, 2023

(54) HEAVYWEIGHT QUOTING AND ASSOCIATING PLANE TYPES WITH PACKAGE SIZES

(71) Applicant: Airspace Technologies, Inc., Carlsbad, CA (US)

(72) Inventors: Ryan RUSNAK, Carlsbad, CA (US); Brett GOING, Carlsbad, CA (US); Raj ALTENHOFF, Carlsbad, CA (US); Ksenia PALKE, Carlsbad, CA (US); Calvin LINFORD, Carlsbad, CA (US)

(21) Appl. No.: 17/492,166

(22) Filed: Oct. 1, 2021

(51) Int. Cl. G06Q 10/08; G01C 21/34; G06N 20/00

(52) U.S. Cl. CPC G06Q 10/08355; G01C 21/3492; G01C 21/3461; G06N 20/00

(57) ABSTRACT

A system and method for generating a route quote for the transportation of heavyweight goods. The route quote is generated based on the mode of transportation, classification of the good, and the classification requirements of service providers along a preferred route.

### BACKGROUND OF THE INVENTION

Currently logistical companies manually calculate quotes relating to orders for transportation of goods into their system. In doing so, current logistic companies have to manually determine an appropriate route for the goods to travel from its current location to a destination location, which sometimes include stops until arriving at the destination location. As such, current logistical companies must manually determine an appropriate transporter (e.g. a truck, train, and a flight) and an appropriate classification of the goods for each leg of the transport. Along these lines, current logistical companies are unable to automatically assess heavyweight regulations based on the classification of the good for each service provider. As such, current logistical companies are unable to predict heavyweight costs and transportation timing associated with the heavyweight good being transported. Accordingly, current logistical companies are unable to automatically calculate a route quote for a suggested route upon receipt of the order.

### SUMMARY OF THE INVENTION

The above-outlined problems are addressed and are at least partly solved by the different aspects of the present disclosure.

In some embodiments, a system, includes a memory and a processor in communication with the memory. In some embodiments, the processor is configured to receive an electronic user request for transporting a good from a pickup location to a destination location, locate, within a pre-generated graph data structure, a pickup node representing the pickup location, and a destination node representing the destination location, locate, within the pre-generated data structure, a plurality of service carriers that service areas along a route from the pickup location to the destination location, wherein each of the service carriers have a corresponding service carrier classification requirement, locate, within the pre-generated graph data structure, a first intermediate node representing a first intermediate location, and a second intermediate node representing a second intermediate location by traversing the pre-generated graph based on the pickup node and the destination node, generate a classification of the good for each service carrier at each intermediate node, wherein the classification of the good is based on specifications of the good and a service carrier's classification requirements, determine a plurality of transportation edges each having a transit cost and a transportation time that both correspond to the classification of the good, wherein the plurality of transportation edges each correspond to one of the pickup location, the first intermediate location, the second intermediate location, and the destination location, determine, using a location and time-based machine-learning model, a tendering edge corresponding to the first intermediate node and the classification of the good, the tendering edge relating to an actual tender time to move the good from a first service carrier that has arrived at the first intermediate location to a tender location of the first intermediate location, determine, using a cargo database, a cargo edge corresponding to the first intermediate node and the classification of the good, the cargo edge relating to a time for loading the good onto a second service carrier upon receipt of the good at the first intermediate location, authenticate the classification of the good with the classification requirements of the first carrier and the second carrier, generate a subgraph of the pre-generated graph including the pickup node, the first intermediate node, the second intermediate node, the destination node, the tendering edge, the cargo edge, the classification of the good with the first carrier, the classification of the good with the second carrier, and the plurality of transportation edges, generate a plurality of potential routes along the subgraph from the pickup location to each intermediate location and then to the destination location, identify a route quote for each of the plurality of potential routes, wherein each route quote includes a total shipment time and a total cost estimate, generate, using the subgraph, a preferred route from the pickup location to the destination location and authorize the preferred route based on the classification of the good and the classification requirements of one or more selected carriers from the plurality of service carriers of the preferred route, and display the preferred route and the route quote.

In some embodiments, the processor is further configured to retrieve service carrier information from one or more databases, wherein the service carrier information relates to the service carrier's classification requirements and includes classification options, size requirements, weight requirements, tender times, recovery hours, hours of operation, special operation hour, holiday schedules, geographical information relating to the pickup location, geographical information relating to the destination location, historical data of transit costs.

In some embodiments, generating the classification of the good includes the process of identifying the plurality of service carriers at each intermediate node, comparing each service carriers' classification requirements to specifications of the good, and determining which classification the good satisfies for each of the plurality of service carriers at each intermediate node. In some embodiments, the specifications of the good include the size of the good, the weight of the good, and the maximum dimension of the good.

In some embodiments, the classification of the good is selected from the group consisting of small parcel, bulk loading, and container loading.

In some embodiments, the preferred route is selected from one of the following categories, lowest route quote for transporting the good, lowest shipment time, and a user preferred route.

In some embodiments, the total cost estimate is the aggregate of the transit cost for each transportation edge along the potential routes.

In some embodiments, the total shipment time is the aggregate of the times related to the transportation edge, tender edge, and cargo edge.

In some embodiments, the processor is further configured to determine, based on the classification and specification of the good whether the good can be consolidated with a second good that is traveling to the same first intermediary location, second intermediary location, or destination location.

In some embodiments, the transit cost is reduced if the good can be consolidated during the preferred route.

In some embodiments, the preferred route utilizes more than one mode of transportation.

In some embodiments, the preferred route utilizes more than one service carrier.

In some embodiments, a computer-implemented method for a transporting of a good, includes receiving, by one or more processors, a user request for the transporting of the good from a pickup location to a destination location, locating, by the one or more processors and within a pre-generated graph data structure, a pickup node representing the pickup location and a destination node representing the destination location, locating, with the pre-graphed data structure, a plurality of service carriers that service areas along a route from the pickup location to a first intermediate node representing a first intermediate location, to a second intermediate node representing a second intermediate location, to the destination location, determining, by one or more processors, a classification of the good at each of the pickup location, first intermediate location, second intermediate location, and destination location for one or more of the service carriers, wherein the classification of the good is based on specifications of the good and a service carrier's classification requirements, determining, by the one or more processors, a plurality of transportation edges that each relate to a transit cost and transportation time associated with a corresponding one of the pickup location, the first intermediate location, the second intermediate location, and the destination location, determining, by the one or more processors and using a location time machine-learning model, a tendering edge corresponding to the first intermediate node and the classification of the good, the tendering edge relating to an actual tender time to move the good from a first service carrier that has arrived at the first intermediate location to a tender location of the first intermediate location, determining, by the one or more processor and using a cargo database, a cargo edge corresponding to the first intermediate node and the classification of the good, the cargo edge relating to a time for loading the good onto a second service carrier upon receipt of the good at the first intermediate location, authenticating the classification of the good with the classification requirements of the first service carrier and the second service carrier, generating, by the one or more processors, a subgraph of the pre-generated graph data structure including the pickup node, the first intermediate node, the second intermediate node, the destination node, the tendering edge, the cargo edge, the plurality of transportation edges, the classification of the good with the first service carrier, and the classification of the good with the second service carrier, generate a plurality of potential routes along the subgraph from the pickup location to each intermediate location and then to the destination location, identify a route quote for each of the plurality of potential routes, wherein each route quote includes a total shipment time and a total cost estimate, generate, using the subgraph, a preferred route from the pickup location to the destination location, authorize the preferred route based on the classification of the good and the classification requirements of one or more selected service carriers from the plurality of service carriers of the preferred route, and display the preferred route and the route quote.

In some embodiments, the computer-implemented method further includes retrieving service carrier information from one or more databases, wherein the service carrier information relates to the service carrier's classification requirements and includes classification options, size requirements, weight requirements, volume requirements, tender times, recovery hours, hours of operation, special operation hour, holiday schedules, geographical information relating to the pickup location, geographical information relating to the destination location, historical data of transit costs, and the limit of the number of individual pieces that can be shipped together.

In some embodiments, determining the classification of the good includes the process of identifying the plurality of service carriers at each intermediate node, comparing each service carriers' classification requirements to specifications of the good, and determining which classification the good satisfies for each of the plurality of service carriers at each intermediate node. In some embodiments, the specifications of the good include the size of the good, the weight of the good, and the maximum dimension of the good.

In some embodiments, the computer-implemented method further includes determining, based on the classification and specification of the good whether the good can be consolidated with a second good that is traveling to a common first intermediary location, second intermediary location, or destination location.

In some embodiments, a computer-implemented method for consolidating the transporting of a plurality of individual goods, includes receiving, by one or more processors, a plurality of user requests for the transporting of goods from a plurality of pickup locations to a plurality of destination location, locating, by the one or more processors and within a pre-generated graph data structure, a plurality of pickup nodes representing the pickup location and a plurality of destination nodes representing the destination location, locating, with the pre-graphed data structure, a plurality of service carriers that service areas along a route from the pickup location to a first intermediate node representing a first intermediate location, to a second intermediate node representing a second intermediate location, to the destination location, locating, by one or more processors and within a pre-generated graph data structure, a common pickup location, intermediate location, or destination location between one or more of the user requests, determining, by one or more processors, if one or more of the goods from the plurality of user requests can be combined into a containment shipment, wherein the determination of the containment of the goods of multiple user requests depends on the size, maximum dimension, weight, and required delivery time of each of the goods, generating, by one or more processors, a preferred containment route for each of the user requests, wherein the preferred containment route for each of the user requests includes a common transportation segment from one or more of the pickup locations, intermediate locations, or destination locations between the user requests, generating, by one or more processors, a preferred individual route for each of the user requests, wherein the preferred individual route for each of the user requests includes a transportation segment to transport the goods to the common transportation segment for the preferred containment route, and generate, using the preferred containment route and the preferred individual route, a preferred total route from the pickup location to the destination location for each user request.

In some embodiments, the computer-implemented method further includes determining, by one or more processors, a classification of each of the goods at each of the pickup locations, first intermediate locations, second intermediate locations, and destination locations for one or more of the service carriers, wherein the classification of the goods are based on the dimensions and weight of the good and a service carrier's classification requirements, authenticate the preferred individual route for each of the user requests based on the classification of each of the goods of the user request with the service carriers' classification requirements, determining, by one or more processors, a classification of the containment shipment of one or more of the goods of one or more user requests at each of the pickup locations, first intermediate locations, second intermediate locations, and destination locations for one or more of the service carriers, wherein the classification of the containment shipment is based on the dimensions and weight of the containment shipment and a service carrier's classification requirements and authenticate the preferred containment route for each of the user requests based on the classification of the containment shipment with the service carriers' classification requirements.

In some embodiments, the computer-implemented method further includes generating a route quote for each of the user requests, wherein each route quote includes a total shipment time and a total cost estimate.

In some embodiments, the computer-implemented method further includes, generating a transportation edge, relating to a transit cost and a transport time from each of the pickup location, intermediate location, and destination location, generating a tender edge relating to an actual tender time to move the good from a first service carrier that has arrived at the first intermediate location to a tender location of the first intermediate location, and generating a cargo edge relating to a time for loading the good onto a second service carrier upon receipt of the good at the first intermediate location. In some embodiments, the total shipment time is the aggregate of the transportation edge, tender edge, and cargo edge.

In some embodiments, the total cost estimate is the aggregate of the transit costs for each transportation edge along the preferred total routes.

### BRIEF DESCRIPTION OF THE DRAWINGS/FIGURES

The accompanying drawings are incorporated herein and form a part of the specification.

FIG. 1 is a block diagram of an example logistical management system, according to some embodiments.

FIGS. 2-4 are example user interfaces of a user request application, according to some embodiments.

FIG. 5 is an example transportation graph generated by a route generator module, according to some embodiments.

FIG. 6 is a block diagram of an example transporter module, according to some embodiments.

FIG. 7 is an example drive-only route constructed by a route generator module in communication with a transport module, according to some embodiments.

FIG. 8 is an example route having a connection as constructed by a route generator module in communication with a transport module, according to some embodiments.

FIG. 9 is example transporters identified by a transporter application, according to some embodiments.

FIG. 10 is an example user interface of a transporter application when waiting for an assignment of an order, according to some embodiments.

FIG. 11 is an example user interfaces of a transporter application upon receipt of an assignment of an order, according to some embodiments.

FIG. 12 is an example user interface of a transporter application for a transporter traveling to a pickup or intermediate location, according to some embodiments.

FIG. 13 is an example user interfaces of a transporter application for a transporter at a pickup or intermediate location, according to some embodiments.

FIG. 14 is an example user interface of a transporter application for a transporter traveling to a destination location, according to some embodiments.

FIG. 15 is an example user interfaces of a transporter application for a transporter at a destination location, according to some embodiments.

FIG. 16 is an example user interface of a transporter application for a transporter upon completion of transportation of goods of an order, according to some embodiments.

FIG. 17 is an example user interface of a transport manager application, illustrating a plurality of orders from different users, according to some embodiments.

FIG. 18 is an example user interface of a transport manager application, illustrating a particular order, according to some embodiments.

FIG. 19 is an example user interface of a transport manager application, illustrating dispatching a transporter for the transport of a particular order, according to some embodiments.

FIG. 20 is an example user interface of a transport manager application, illustrating a digest of a particular order, according to some embodiments.

FIG. 21 is a block diagram of an example routing generator module, according to some embodiments.

FIG. 22 is a block diagram of an example classification submodule, according to some embodiments.

FIG. 23 is a block diagram of an example quote generator submodule, according to some embodiments.

FIG. 24 is a block diagram of an example containment submodule, according to some embodiments.

FIG. 25 is an example transportation graph generated by a route generator module, according to some embodiments.

FIG. 26 is an example size chart, according to some embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for providing an end-to-end suite for managing the transport of goods from receipt of an order to transport of the goods to a destination location.

Current logistical systems have many shortcomings in automatically, accurately and efficiently determining an appropriate route from a pickup location to a destination location, upon receipt of a request for transport of goods, and without assistance from a user. First, current logistical systems typically require user intervention for determining the appropriate route and coordinating the transportation of the goods among stops (e.g., pickup location, intermediate locations, and destination location) of the appropriate route. Specifically, upon receipt of the request, authorized users typically manually determine the appropriate route from the pickup location to the destination location. In doing so, authorized users will communicate with transporters and/or methods of transportation to arrange for transport of the goods. As such, for example, authorized users will communicate with a transporter (e.g., a driver) to pick up goods from a pickup location and deliver the goods to a first intermediate location (e.g., an airport). Authorized users will then communicate with a transportation company for transportation of the goods from the first intermediate location to a second intermediate location (e.g., an airport). Authorized users will then communicate with a transporter (e.g., a driver) to pick up the goods from the second intermediate location and deliver the goods to a destination location. In doing so, current logistical systems have difficulty in efficiently determining an appropriate and accurate price quotes for the transport of such goods. More specifically, for the transportation of heavyweight goods, which might need to be transported through specific modes or procedures. The additional factors associated with the transportation of heavyweight goods includes bulk loading, complying with flight freight size requirements, bulk or container loading, and freight cargo services.

Second, current logistical systems do not consider the preferences of users requesting the transport of goods. For example, current logistical systems do not consider that some users do not like particular methods of transportation (e.g., airplane or train) or particular carriers (e.g., United Airlines or BNSF Railway), to provide a few examples. Accordingly, when determining the appropriate route, current logistical systems do not accurately determine modified costs for different potential routes (and segments) based on user preferences.

Third, current logistical systems do not consider many variables inherent to various potential routes from the pickup location to the destination location. For example, current logistical systems do not consider a transport time for particular transporters (e.g., drivers) to arrive at pickup locations and deliver goods to intermediate and destination locations. Further, current logistical systems do not consider a tender time for particular transporters to receive goods at a pickup location and deliver goods to intermediate destination locations. Accordingly, when determining the appropriate route, current logistical systems do not consider that different pickup, intermediate, and destination locations have different transport, tender, and recovery times. In addition, current logistical systems do not consider that transport, tender, and recovery times may depend on the transporter. For example, some transporters are slower or faster than other transporters. Moreover, current logistical systems do not consider that transport, tender, and recovery times may depend on whether or not the goods being transported are classified as a small parcel, bulk loading, or container. For example, if the good is classified as bulk or freight, additional factors may be considered such as whether the good can fit through the door of an aircraft, whether the service provider has a service that can support such a good, and whether the service has machinery which can load the good onto the aircraft. Further, depending on the carrier selected, the classification system may vary. Therefore, a good may be classified as a small parcel with one carrier, but classified as a bulk load with another carrier. Hence, these distinctions should be consider to provide a more accurate price quote for the associated goods.

Fourth, when determining transporters to pick up goods from the pickup or intermediate locations and deliver the goods to the intermediate or destination locations, current logistical systems do not consider all potential transporters capable of transporting the goods. For example, some logistical systems solely determine transporters based on an actual cost. Other logistical systems do not properly compare transporters.

Due to these shortcomings, product delays and inaccurate quoting occurs through the miscalculation of each transportation segment cost (depending on the actual classification of the goods)

In overcoming the aforementioned shortcomings, the present disclosure provides a central server including a database, user request application, a route generator module, a quote generator module, a transporter application, and/or a transport manager application. The database includes geographical data for all transportation services and hubs, along with carrier specific information including classification information, tender hours, recovery hours, holiday schedules, parcel size requirements. The user request application receives an electronic request for transport of a good from a recipient of the good (e.g., a consumer or a hospital) or a transportation company (e.g., United Parcel Service or FedEx Corporation). The electronic request includes a pickup location, a destination location, a service type (e.g., recommended, fastest routing, economy routing, and drive-only), dimensions of the goods (e.g. height, width, and depth), weight of the goods, and a commodity type (e.g., aircraft parts, computer equipment, documents, electronic equipment, medical device/part, dangerous goods). The route generator module includes a classification submodule that determines which classification is accurate for the transported goods. Further, the route generator module creates several route options that satisfy the selected user preferences from the request application. Once the route options are determined, the quote generator module calculates the cost associated with each node of each of the route options. The node costs for each route option are summed and an estimated route quote is generated for each route option. The user is then prompted with several route options and their associated delivery times and cost. The user is prompted with a fastest route, an economy route, a recommended route, and drive-only route. The fastest route is calculated such that time to delivery is given the most weight compared to other factors. The economy route is calculated where cost is given the most weight compared to other factors. The recommended route is calculated based on the cost per time to delivery. The drive-only route is calculated based on the service provider's rate per mile of the route.

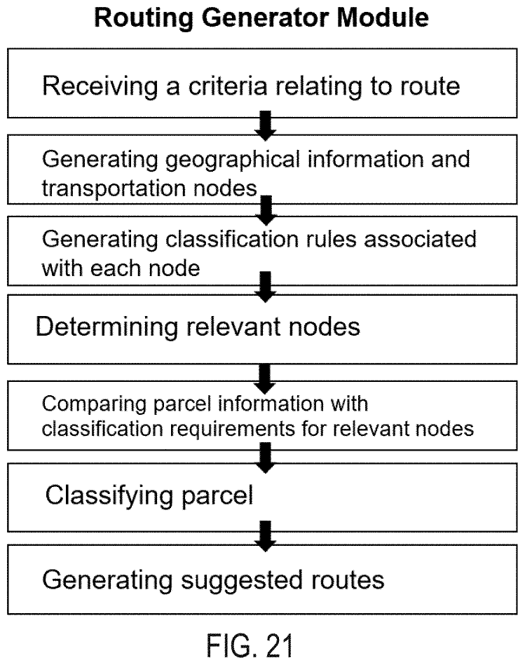

In some embodiments, for example, as shown in FIG. 21, a route generator module operates by receiving criteria relating to a route by a user. The criteria can be in the form of an electronic user request, a phone call request, or an in-person order. The user request includes information including the parcel specifications, the pickup location, destination location, any timing requirements, and any user preferences. The route generator module then generates geographical information and transportation nodes between the pickup location and destination location, along with generating classification rules and requirements for each service carrier that services the area being traveled. This includes any service carriers that may only be used for an intermediate location or a portion of the total route. The route generator module compares the parcel specifications with each service carrier's classification requirements to determine the classification of the parcel at each node or transportation segment along the route. In some embodiments, the classification of the parcel may differ from one node to another node, and the classification may differ from one service provider to another. Once the parcel has been classified for each service carrier at each node along the route, the route generator module analyzes the classification of the parcels at each node to predict the cost and associated time with each transportation segment along the route. The route generator module then combines transportation segments to generate one or more suggested routes from the pickup location to the destination location. In some embodiments, the suggested routes can include the route with the lowest shipment cost, the route with the fastest shipment time, or a route that satisfies a specific user preference.

In some embodiments, the route generator module further includes, determining a plurality of relevant nodes based on cost, transportation time, tender time, and recovery time. For example, in some embodiments, an algorithm will analyze the nodes to determine if one node has a long tendering time in comparison to other nodes. The nodes with lower times will be characterized as a relevant node. A node with a long tendering, transportation, or recovery time may be excluded from the plurality of relevant nodes to be analyzed by the route generator module. In some embodiments, the route generator module then compares the parcel specifications on an as-needed basis with each of the relevant nodes to generate a suggested route from the pickup location to the destination location. This analysis may lead to a suggested route without having to analyze all possible nodes. This reduces the amount of data being analyzed down to only the data for the relevant nodes and provides a more efficient system for generating a suggested route and an associated route quote.

In some embodiments, upon submission of the order, for determining a preferred route and associated quote from the pickup location to the destination location, the route generator module receives a pre-generated graph from the geographical data module. The pre-generated graph has geographical data, including all potential pickup locations, potential intermediate locations, and/or potential destination locations. Route generator module may then translate the graph and identify the pickup and delivery locations specified in the request and all potential intermediate locations. Route generator module may then identify all potential routes from the pickup location to the destination location, which may include one or more intermediate routes.

The route generator module includes a classification submodule that determines the classification of the transported goods and determines whether or not a particular intermediate location or service line is accessible for the goods. Depending on the carrier, the amount of classifications of goods may vary. Some classifications vary between the parcel weight, parcel dimensions, and the commodity being transported. The main classifications may include small parcel, bulk loading, container loading, and medical or special equipment loading, however each carrier may define the classification requirements differently. Therefore, the classification submodule includes a set of classifications and their respective qualification rules for each carrier and each node analyzed by the route generator module. In some embodiments, the classification submodule will authenticate the classification of the parcel and once authenticated, will authorize the route generator module to select intermediate locations and service lines that require the particular classification of the parcel.

A transportation graph may be generated from the pre-generated graph, wherein the transportation graph may include many potential transportation segments making up the potential routes from the pickup location to the destination location and including potential intermediate locations. For example, the potential transportation segments may include a segment from the pickup location to an intermediate location, a segment from an intermediate location to another intermediate location, and a segment from an intermediate location to a destination location. The transportation segments may relate to the same or different transportation types (e.g., cars, trains, flight). For example, one potential route may be a driving route from a pickup location (e.g., a manufacturing center) to an intermediate location (e.g., a trucking stop) and then from the intermediate location to a destination location (e.g., a store). Another potential route may include a driving route from a pickup location (e.g., a hospital) to a first intermediate location (e.g., an airport), a flight from the first intermediate location to a second intermediate location (e.g., an airport), and a driving route from the second intermediate location to a destination location (e.g., hospital). The potential transportation segments may relate to the same or different service carriers (e.g. American Airlines, Delta, UPS, FedEx).

Each transportation segment is assigned a segment cost and an estimated segment time. The segment cost is an estimated cost calculated based on historically observed factors including standard shipping and transportation rates, parcel or goods classification, parcel weight, parcel dimensions, parcel type, required mode of transportation, and any other related factors. Depending on which carrier is selected for each transportation segment, the projected cost is dependent on the associated parcel classification. For example, if a flight is selected through a first airline, the parcel might be classified as a bulk load and subject to bulk loading fees and regulations; whereas if a second airline was selected the parcel might be classified as a small parcel and subject to small parcel fees and regulations, which differ from bulk loading.

As described above, each classification has its own requirements and associated rules. For example, a small parcel may have different tender hours or recovery hours than bulk loading or container shipping. Once the parcel is classified, the module compares the parcel information to the classification rules to authenticate that the parcel satisfies the requirements. This process of classifying and comparing is repeated for each edge of the transportation segments (e.g. a parcel may be classified as small parcel at one segment of the route, and classified as bulk loading for the next segment of the route).

A quoting module predicts the cost of each transportation segment through analyzing the parcel information, route distance, and parcel classification. Depending on the classification, the quoting module utilizes a different method of predicting cost. For small parcel, the quoting module calculates a flat rate dependent on the parcel information and the rate is multiplied by the distance being traveled. For bulk loading, certain carriers have unique rates and the quoting module calculates the quote by analyzing a plurality of quoting factors. These factors include parcel size, parcel weight, parcel volume, longest dimension of the parcel, type of commodity, cargo door size, time of day, time of the month (including holidays), day of the week, geographical area, historical data, flight freight rules, transportation requirements (TSA certifications or other driver certifications), priority edges, margin of error multiplier, and availability on the cargo unit. In some embodiments, a machine-learning model may help to confirm or modify the provided quote. For example, machine-learning model may more accurately predict future costs of new routes by analyzing availability of parcel space within cargo units of previous routes and factoring in previous re-routes that occurred at certain edges. For container loading, certain carriers have unique container sizes and rates for each container. The quoting module factors in the carriers container rules and compares those rules to the parcel dimensions and delivery time to calculate a price quote. These calculations are performed at each edge of the transportation segment and the final price quote is the sum of the edge costs.

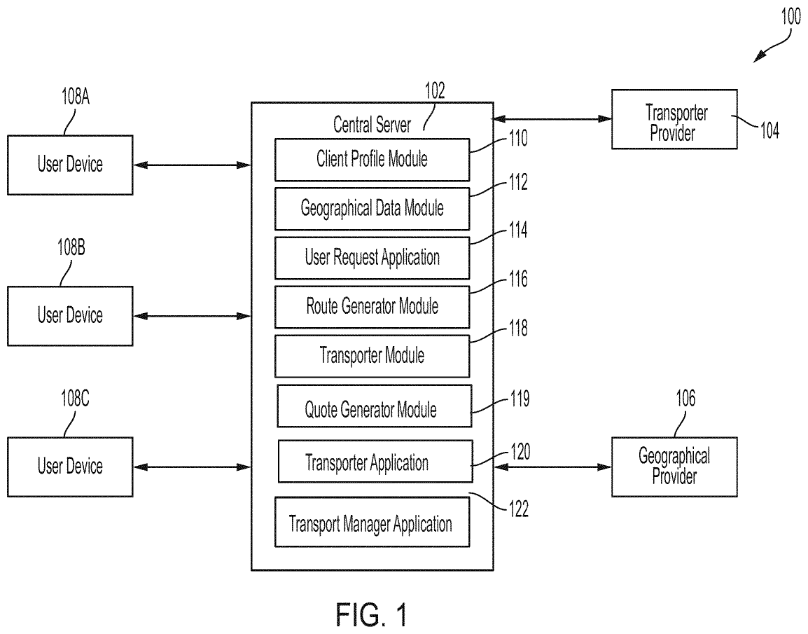

FIG. 1 is a block diagram of an example logistical management system (LMS) 100 according to some embodiments. LMS 100 may include a central server 102, transporter provider 104, geographical provider 106, and/or user devices 108A-C. As will be discussed in more detail below, central server 102 may receive and process requests for transporting goods from users of user devices 108A-C. As such, in some embodiments, users may be a carrier delivery service company (e.g. United Parcel Service or FedEx Corporation). User devices 108A-C may be a personal digital assistant (PDA), a desktop workstation, a laptop or notebook computer, a netbook, tablet, a smart-phone, or any other type of electronic device, to name a few non-limiting examples.

Central server 102 may be in communication with transporter provider 104 and/or geographical provider 106. Transport provider 104 may provide transport data of various transportation modes (e.g., airlines, trains, freight trucks). In some embodiments, central server 102 is in communication with multiple transportation providers 104 providing transportation information for specific types of transportation and/or companies. For example, transportation providers may be American Airlines, Amtrak, and J.B. Hunt Transport Services. As such, central server 102 may be in communication with multiple different transportation providers 104 of the same or different types (e.g., train carriers, airline carriers, and vehicle carriers).

Further, geographical provider 106 may provide geographical data required to process the request. As will be discussed in more detail below, the request includes a pickup and destination location, and, in processing the request, central server 102 may identify intermediate locations, which relate to stops between the pickup location and the destination location. Accordingly, geographical provider 106 may provide geographical data relating to the pickup, intermediate, and destination locations. As such, where the transporter is a vehicle, geographical data may include traffic and navigational data to pick up, intermediate, and destination locations at different times and days. Along these lines, geographical data may also include information on the pickup, intermediate, and destination location (e.g., parking, precise pickup locations (e.g., department), walking directions, and a map). Geographical provider 106 may continually provide geographical data in real-time.

In receiving and processing requests, central server 102 includes user profile module 110, geographical data module 112, user request application 114, route generator module 116, quote generator module 119, transporter module 118, transporter application 120, and/or transport manager application 122.

User profile module 110 stores user profiles. As discussed above, users may be a transportation company requesting transport of goods for their users (e.g., clients) or those requesting transport of their personal goods. As such, user profiles may be for the transportation companies requesting transport for their users or those wishing to transport their own goods. User profiles may include personal information (e.g., a name, a home address, a phone number, and an email address), previous shipping information (e.g., types of previously transported goods, sizes of previously transported goods, previous departing locations, and previous destination locations), and user preferences (e.g., a particular transportation type or carrier). Further, in some embodiments, as will be discussed in more detail below, user profiles may include a user value of time (which is used to derive a recommended route for the user).

Geographical data module 112 may store geographical data received from geographical provider 106 and/or from an authorized user. The geographical data may relate to the transport of goods. As discussed above, transporters may pick up goods from a pickup location or an intermediate location, and drop off the goods at the intermediate location, another intermediate location, or the destination location. In some embodiments, the geographical data may relate to potential pickup locations, potential intermediate locations, and potential destination locations. The potential pickup and destination locations may be any physical location relating to the user seeking transport of the good, such as a personal residence (e.g., a house) or a place of business (e.g., a package delivery company, a hospital, a car manufacturer). The potential intermediate locations may be related to one or more modes of transportation. In some embodiments, the modes of transportation may be rail (e.g., trains), air (e.g., airlines), road (e.g., cars, trucks). In some embodiments, the potential intermediate locations may be physical locations related to the modes of transportation. For example, where the mode of transportation is air, the potential intermediate locations may be private or public airports. Likewise, where the mode of transportation is road, the potential intermediate locations are truck stops.

Further, in some embodiments, geographical data module may also include transit information relating to the potential pickup locations, the potential intermediate locations, and the potential destination locations. In some embodiments, the transit information may also include prescheduled departure dates and times, prescheduled arrival dates and times, and/or prescheduled transport times, for example, for an airline and/or a freight. In some embodiments, geographical data may also include cutoff times before departure for receipt of goods, for example, for an airport or a train station.

Along these lines, the transport data may also relate to each potential route from the potential pickup locations to the potential intermediate locations or the potential destination locations, and from the potential intermediate locations to other potential intermediate locations and the potential destination locations. In some embodiments, the transit information may include driving data (e.g., navigational data, traffic data, road closure data, etc.). Along these lines, geographical data module 112 may receive updates from geographical provider 106 relating to the transit information (e.g., new departure dates and updates, new arrival dates and times, new transport times, new routes, etc.).

Geographical data module 112 may also generate a graph for route generator module 116 to utilize for generating a preferred route from a pickup location to a destination location. Geographical data module 112 may generate a graph (pre-generated graph) based on geographical data received from geographical provider 106 and/or provided by an authorized user. In some embodiments, the pre-generated graph includes nodes of all potential pickup locations, potential intermediate locations, and/or potential destination locations. In some embodiments, the graph further includes all potential routes for traveling from the potential pickup locations to the potential intermediate locations, from the potential pickup locations to the potential destination locations, from the potential intermediate locations to other potential intermediate locations, and/or from the potential intermediate locations or to potential destination locations.

User request application 114 receives electronic requests for transporting goods from user devices 108A-C. User request application 114 may then process a request for transporting goods from a starting pickup location to a destination location. As discussed above, intermediate companies may utilize user request application 114 on behalf of their consumers. Additionally, consumers may directly utilize user request application 114 to transport goods.

Central server 102 further includes route generator module 116 to generate a preferred route from a pickup location to a destination location. In some embodiments, upon user request application 114 receiving a user request, user request application 114 sends the request to the route generator module 116, which requests the pre-generated graph, as discussed above, from geographical data module 112. Route generator module 116 then translates the pre-generated graph to identify the user request's pickup and destination locations. In some embodiments, route generator module 116 also identifies potential intermediate locations corresponding to the pickup and destination locations based on the geographical data. In some embodiments, route generator module 116 analyzes each transportation segment to determine the classification of the transported goods and analyzes whether or not the transported goods satisfy the classification requirements.

As discussed above, the potential intermediate locations relate to locations for products to change carriers and/or modes of transportation to arrive at the destination location. In some embodiments, the potential intermediate locations corresponding to the pickup and destination locations provided in the request are less than all potential intermediate locations provided in the pre-generated graph. In some embodiments, route generator module 116 can also identify transit information for the pickup location, each potential intermediate location, and the destination location, as described above.

Further, route generator module 116 also identify potential routes from the pickup location to each potential intermediate location, from the pickup location to the destination location, from each potential intermediate location to another potential intermediate location, and/or from each potential intermediate location to the destination location. In some embodiments, route generator module 116 may identify multiple potential routes from one location to another location. For example, route generator module 116 may identify multiple routes from the pickup location to a potential intermediate location.

Route generator module 116 may generate a subgraph from the pre-generated (transportation graph) based on the pickup location, the destination location, the potential intermediate locations, and/or the potential routes. In some embodiments, route generator module 116 may generate the potential routes after generating the subgraph. In some embodiments, route generator module 116 may generate the subgraph with the potential routes.

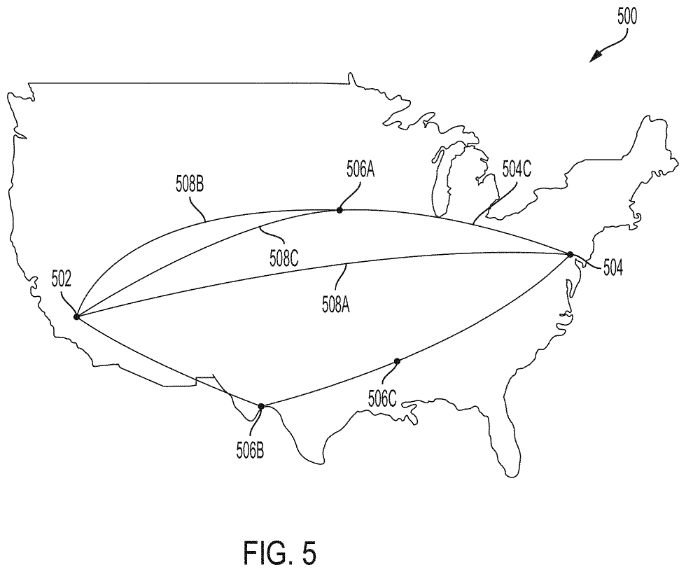

FIG. 5 is an example transportation graph 500 for the transport of goods from pickup location 502 to destination location 504. In some embodiments, transportation graph 500 is the pre-generated graph received from geographical data module 112 (of FIG. 1). In some embodiments, transportation graph 500 is a subgraph of the pre-generated graph.

Further, as discussed above, in some embodiments, transportation graph 500 may include any combination of potential intermediate locations 506A-C. For example, in some embodiments, transportation graph 500 may include a single potential intermediate location 506A. Further, in some embodiments, transportation graph 500 may include multiple potential intermediate locations 506B and 506C.

Accordingly, in some embodiments, transportation graph 500 may include potential transportation segments 508A-G relating to the potential routes from starting location 502 to destination location 504, from starting location 502 to each potential intermediate location 506A-C, from each intermediate location 506A-C to another potential intermediate location 506A-C, and from each intermediate location 506A-C to destination location 504. In some embodiments, transportation graph 500 may include a single potential transportation segment 508A and 508B from pickup location 502 to destination location 504, and a single potential transportation segment 508B from pickup location 502 to potential intermediate location 506B or destination location 504. Further, in some embodiments, transportation graph 500 may also include a single potential transportation segment 508C from one potential intermediate location 506B to another potential intermediate location 506C. Along these lines, in some embodiments, transportation graph 500 may also include multiple potential transportation segments 508D and 508E from pickup location 502 to potential intermediate location 506A. Further, transportation graph 500 may include a potential transportation segment 508F from potential intermediate location 506A to destination location 504, and also include a potential transportation segment 508G from potential intermediate location 506C to destination location 504.

As described above, pickup location 502, potential intermediate locations 506A-C, and destination location 504 may relate to the same or different modes of transportation locations (e.g., airports, train stations, trucking stations, etc.). Accordingly, potential transportation segments 508A-G may relate to the same or different modes of transportation (e.g., vehicle, airplane, train, waterway, etc.). For example, potential transportation segments 508D and 508E—from pickup location 502 to potential intermediate location 506A—may relate to the same mode of transportation (e.g., airplane). Alternatively, potential transportation segment 508D may relate to one mode of transportation (e.g., vehicle), while potential transportation segment 508E may relate to another mode of transportation (e.g., airplane). The same may apply from pickup location 502 to destination location 504 and from one potential intermediate location 506B to another potential intermediate location 506C. As such, a complete route from pickup location 502 to destination location 504, with or without intermediate locations 506A-C, may utilize the same or different modes of transportation.

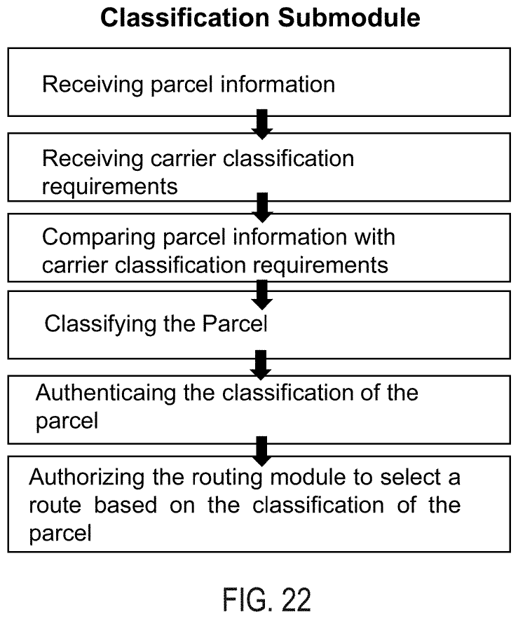

After generating the subgraph from the pre-generated graph, route generator module 116 (of FIG. 1) also receives transport data relating to the pickup location 502, destination location 504, each potential intermediate locations 506A-C, and potential transportation segments 508A-G based on the classification of the good from classification submodule 130 (of FIG. 22). In some embodiments, route generator module 116 may be in communication with transporter module 118 to determine one or more transformation edges for each of pickup location 502, destination location 504, and each potential intermediate location 506A-C. Route generator module 116 may associate the transformation edges to the pickup location 502, destination location 504, and/or each potential intermediate location 506A-C.

Classification submodule 130 determines the classification of the transported goods and determines whether or not a particular intermediate location or service line is accessible for the goods. Depending on the carrier being used for each transportation segment, the classifications of the goods may vary. Some classifications vary between the parcel weight, parcel dimensions, and the commodity being transported. The main types of classifications include small parcel, bulk loading, container loading, and medical or special equipment loading, however each carrier may define the classification requirements differently. Therefore, the classification submodule 130 includes a set of classifications and their respective qualification rules and requirements for each carrier and each node analyzed by the route generator module 116. In some embodiments the classification submodule 130 will authenticate the classification of the parcel and once authenticated, will authorize the route generator module 116 to select intermediate locations and service lines that require the particular classification of the parcel.

The classification submodule 130 receives parcel information from the user request application 114 and receives carrier classification requirements from transporter provider 104. Classification submodule classifies parcel for each potential carrier along the pre-generated graph. In some embodiments, classification submodule may include a machine-learning model to authenticate the classification of the parcel based on factors including prior classification of similar parcels, prior carrier classification patterns, and prior re-classifications of parcels. In some embodiments, classification submodule 130 may authorize the route generator module to select a route that requires the parcel to be a specific classification. For example, if a route requires the parcel to be classified as small parcel under a particular airline's classification requirements, classification submodule 130 will authenticate whether or not the parcel satisfies the small parcel requirements, and if so, authorize the route generator module 116 to select that route.

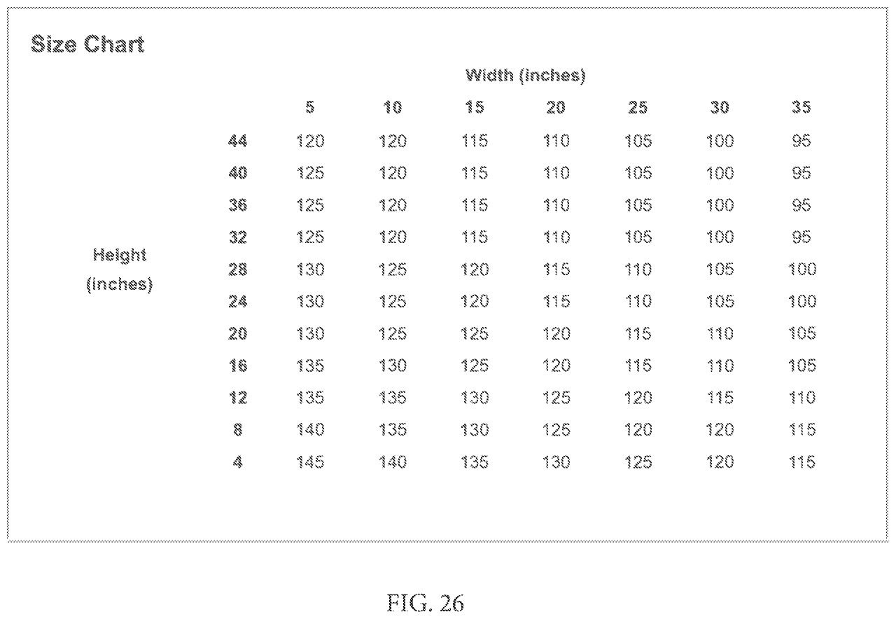

Classification of a parcel is determined by a number of factors including, but not limited to the weight, height, width, maximum dimension and type of commodity of the parcel, along with cargo door clearance dimensions, maximum bulk piece weight, maximum pallet height, and requirements related to the handling of dangerous goods (including dry ice, batteries, or chemical transportation limitations and kennel acceptability of the carrier and transportation vehicle or aircraft). As described above, the requirements for each classification varies depending on the carrier being used (e.g. a particular airline) and which transportation vehicle or aircraft is being used for the transportation segment (e.g. Boeing 878, Boeing 737, Airbus 321, etc.). For example, FIG. 26 shows a size chart of maximum parcel sizes for a Boeing 787 airbus.

Classification submodule 130 will also look to transporter provider 104 for container information. Container information can include International Air Transport Association Classification (IATA), Unit Load Device (ULD) Type, maximum gross weight, maximum net weight, tare weight allowance, cooling range, maximum external dimensions, maximum loading space dimensions, and additional loading space under cooling unit dimensions.

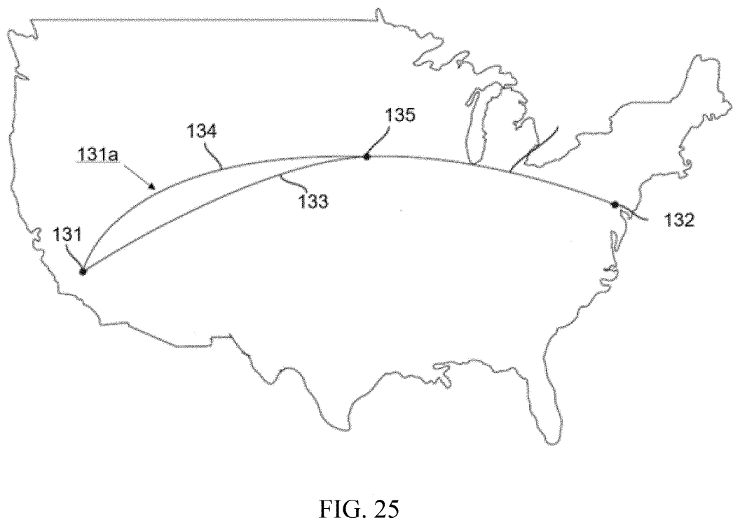

Once each node and transportation segment of each potential route has been analyzed, classification submodule 130 authorizes route generator module 116 to utilize any node which the parcel satisfies the respective classification requirements. For example, in FIG. 25, a parcel weighing 2001b is being transported from the pickup location 131 to the destination location 132. Classification submodule 130 analyzes each transportation segment along route 131a to check which classifications the 2001b parcel would fall within. Route 131a travels from pickup location 131 to intermediate location 135 to destination location 132. Route 131a has two options 133 and 134 to travel to intermediate location 135. Upon analyzing both options, classification submodule 130 would reject transportation segment 133, which utilizes American Airlines' small parcel line because the parcel exceeds American Airlines' small parcel classification, and therefore must be shipped through bulk loading with American Airlines. Conversely, classification module 130 accepts transportation segment 134 because a 2001b parcel satisfies the small parcel requirement of Southwest Airlines. Therefore, classification submodule would authorize route generator module 116 to utilize transportation segment 134.

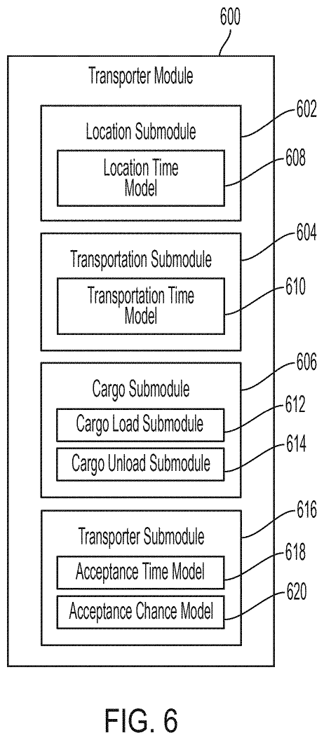

The timing and costs associated with the each transportation segment are determined by the transporter module 600. FIG. 6 illustrates an example transporter module 600 including location submodule 602, transportation submodule 604, and cargo submodule 606. As will be described in more detail below, location submodule 602 can provide a tendering edge corresponding to an actual tendering time at each of pickup location 502, destination location 504, and each potential intermediate location 506A-C (of FIG. 5). Transportation submodule 604 can provide a transportation edge corresponding to an actual transport time or actual transport cost for each potential route from each of pickup location 502, destination location 504, and each potential intermediate location 506A-C. Cargo submodule 606 can provide a cargo edge providing a load or unload time of the good at each of pickup location 502, destination location 504, and each potential intermediate location 506A-C. Location submodule 602 determines an amount of time for a particular or average transporter to perform tendering good actions at the pickup location, each potential intermediate location, and the destination location (“actual tender time”). Tendering good actions at pickup locations relate to transporters arriving at the pickup location, receiving the goods, and returning to their mode of transportation. Likewise, tendering good actions at the intermediate and destination locations relate to arriving at the intermediate or destination locations and tendering the goods.

For example, in some embodiments, determining the actual tender time at the pickup location, location submodule 602 may include determining an aggregate amount of time for a particular transporter to park their vehicle at the pickup location (e.g., hospital), walk a particular place of the pickup location (e.g., a lab), receive the goods (e.g., scanning and signing for the packages of goods), and return to their vehicle. Likewise, determining the actual tender time at an intermediate location, location submodule 602 may include determining an aggregate amount of time for a particular transporter to park their vehicle at the intermediate location (e.g., airport), walk to a tender location of the intermediate location (e.g., cargo window), and tender the goods (e.g., wait in line and fill out the appropriate paperwork). Similarly, determining the actual tender time at the destination location, location submodule 602 may include determining an aggregate time for a particular transporter to park their vehicle at the intermediate location (e.g., airport), walk to the tender location (e.g., a different hospital), walk a particular place of the pickup location (e.g., a surgery center), and provide the goods (e.g., receiving a signature). In some embodiments, location submodule 602 may consider that different parcel classifications have different processing times.

Along these lines, in some embodiments, location submodule 602 includes location time model 608 to predict the actual tender time at the pickup location, each potential intermediate location, and the destination location. In some embodiments, location time model 608 may be a machine-learning model trained on historical tender times for known pickup, intermediate, and destination locations and known transporters. In some embodiments, location time model 608 may consider that different pickup, intermediate, and destination locations have different processing times based on, for example, size, wait time, and processing requirements. In some embodiments, location time model 608 may consider that different parcel classifications have different processing times. Along these lines, location time model 608 may consider that different transporters take different tender times to at the pickup, intermediate, and destination locations. For example, some transporters may walk to and from a location quickly, whereas other transporters may do so slowly.

Further, in some embodiments, for determining the actual tendering time, location time model 608 considers the current waiting times of the pickup, intermediate, and/or destination locations for receiving, tendering, and/or delivering the goods, respectively. Accordingly, location time model 608 may increase any previously determined transport time by a waiting time for tendering the goods. Additionally, in some embodiments, location time model 608 may predict the amount of time for new pickup/intermediate/destination locations (e.g., where transporters have not previously picked up or delivered goods). In doing so, location time model 608 may consider publically known data of the new pickup/intermediate/destination location and transporters' historical times for known pickup/destination locations. Publically known data on the new pickup/destination location may include an average number of individuals (e.g., at various times throughout the day), type of location (e.g. hospital, warehouse, airport, or medical office), time of day, day of week (some locations are easier to navigate during business hours), type of goods. and a size of the location.

Transportation submodule 604 determines an actual transport time or an actual cost for a particular or average transporter to transport the goods from one location to another location (“actual transport time” or “actual transport cost”). The actual transport time and/or actual transport cost may depend on a mode of transportation (e.g., train, car, and airplane), current transport data (e.g., available routes and current traffic), and transporter's historical transport data (e.g., average miles per hour and an average amount of travel time). In some embodiments, the actual transport time and/or the actual transport cost may be received from transporter provider 104 (of FIG. 1). In some embodiments, transportation submodule 604 may include a transportation time or cost model 610 to predict the actual transport time or the actual transport cost. Transport time or cost model 610 may be a machine-learning model trained on previously utilized transport data (e.g., used routes, traffic for particular routes, an average speed, and an average amount of travel time) for a particular or average transporter utilizing a particular mode of transportation.

Cargo submodule 606 determines an amount of time for loading or unloading goods at the pickup location, each potential intermediate location, and the destination location (“actual cargo time”). In some embodiments, cargo submodule 606 includes cargo load submodule 612 and cargo unload submodule 614. Cargo load submodule 612 determines an amount of time for placing and loading goods on a method of transportation upon receipt from an intermediate location (“actual cargo load time”). For example, upon tendering a particular package to an airport, cargo load submodule 612 determines the amount of time for the airport to place the package on the flight. In some embodiments, the cargo load time may be the method of transportation's cutoff time for receiving packages (e.g., 1 hour before takeoff). In some embodiments, the cargo load time may be based on the cutoff time, the departure time, and the cargo load time. Additionally, the cargo load time may be further based on a cargo open and closed time provided by the method of transportation (e.g., 6:00 AM-12:00 AM). In some embodiments, the cargo load time and unload time may be based on the classification of the parcel. In some embodiments, cargo submodule 606 may be a machine-learning model trained on historical loading and unloading times for known pickup, intermediate, and destination locations and known transporters

To determine the actual cargo load time, cargo load submodule 612 receives the cutoff time, departure time, classification of the parcel, and/or cargo open and closed time from transporter provider 104 of FIG. 1 (e.g., American Airlines, United Airlines, etc.) or a transportation agency (e.g., airport, train station, etc.). Accordingly, cargo load submodule 612 may update the cargo load time based on feedback by the transporter provider 104 (of FIG. 1) and the transportation agency. For example, if a flight is delayed an hour, cargo load submodule 612 will move the cutoff time and departure time back an hour.

Cargo unload submodule 614 determines an amount of time for unloading the goods from a method of transportation (“actual cargo unload time”). Like cargo load submodule 612, cargo unload submodule 614 receives the cargo arrival time, the cargo unload open time, the cargo unload close time, classification of the parcel, and/or a transportation agency (e.g., airport, train station, etc.) from transporter provider 104 (e.g., American Airlines, United Airlines, etc.). Accordingly, cargo unload submodule 614 may update the actual cargo unload time based on feedback by the transporter provider 104 (of FIG. 1) and the transportation agency.

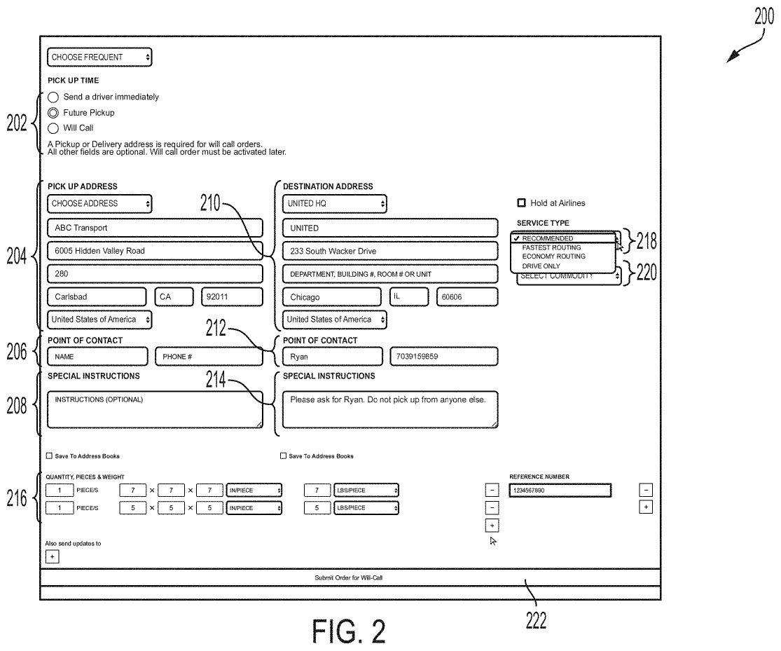

In some embodiments, after associating transporter module 118's transport data with one or more edges of transportation graph 500's pickup location 502, destination location 504, potential intermediate locations 506A-C, and potential transportation segments 508A-G (of FIG. 5) (e.g., a tendering edge, a transportation edge, and/or a cargo edge), route generator module 116 may request user preferences and/or a user value of time from user profile module, which may be unique to a user seeking transport of the good. Route generator module 116 may then determine an optimal route based on user-selected service type 218 (of FIG. 2). As discussed above, user-selected service type 218 may be one of a fastest route, a drive-only route, an economy route, and/or a recommended route.

In some embodiments, where user-selected service type 218 is the fastest route, route generator module 116 may generate a preferred route from pickup location 502 to destination location 504 (of FIG. 5) based on the least amount of time and/or on the user preference. Route generator module 116 may select the preferred route irrespective of the actual cost for transporting the good. For instance, route generator module 116 can select segment 508A to route a good from pickup location 502 to destination location 504 although other segments may have a lower cost. Along these lines, if the user prefers a certain mode of transportation or carrier, route generator module 116 can select segments corresponding to the preferred mode of transportation or carrier, although other segments permit the good to arrive at destination location 504 sooner.

In some embodiments, where user-selected service type 218 is drive-only and economy route, the preferred route from pickup location 502 to destination location 504 is based on the actual cost and the user preference. In some embodiments, for the recommended route, route generator module 116 generates a preferred route from pickup location 502 to destination location 504 (of FIG. 5) based on actual cost, user preference, and a likelihood of route approval. Along these lines, as illustrated above with respect to FIG. 6, the transport and location data may be in the form of time (e.g., minutes) and actual cost (e.g., dollars). Accordingly, as stated above, in some embodiments, for the drive-only, economy, and recommended routes, route generator module 116 may determine a true user cost relating to the pickup location, potential intermediate location, destination location, and/or potential transportation segments. In some embodiments, for the drive-only and economy routes, route generator module 116 may determine a cost per interval of time (e.g., 2 dollars per minute) or a time per monetary unit (e.g., 2 minutes per dollar). In some embodiments, route generator module 116 determine a cost per interval of time or a time per monetary unit based on previous user orders. In some embodiments, the cost per interval of time may be (Avg$PerMin(OnOperationsOrCustomerApprovedOrders)*ApprovalWeight)+(Avg$PerMin (OnOperationsOrCustomerDisapprovedOrders)*DisapprovalWeight). In some embodiments, when the user is new, route generator module 116 may assign a predetermined cost per interval of time (e.g., 2 dollars per minute) or a predetermined time per monetary unit (e.g., 2 minutes per dollar) for the user.

As such, for the economy and drive-only routes, where there is an actual cost (e.g., dollars) associated with potential intermediate locations 506A-C and potential transportation segments 508A-G (of FIG. 5), the client cost=actual cost×(‘cost per interval of time’ or ‘time per monetary unit’). For example, route generator module 116 may consider a first and second potential route. The first potential route comprises a flight from pickup location 502 to destination location 504 (“potential transportation segment 508A”). The second potential route comprises a drive from pickup location 502 to intermediate location 506B (“potential transportation segment 508B”), a flight from intermediate location 506B to intermediate location 506C (“potential transportation segment 508C”), and a drive from intermediate location 506C to destination location 504 (“potential transportation segment 508G”). Potential segments 508A-C and G may have an actual cost of $150, $10, $100, and $10, respectively. Further, the waiting times at the intermediate locations 506B and 506C may each be 40 minutes. Accordingly, assuming that minute per dollar is 2, route generator module 116 may determine that the total client cost for the first potential route is 300 minutes ($150×2 ‘minutes per dollar’) and that the total client cost for the second potential route is 320 minutes (($10×2 ‘minutes per dollar’)+(40 minutes)+($100×2 ‘minutes per dollar’)+(40 minutes)+($10×2 ‘minutes per dollar’)). Accordingly, although the first potential route has an actual cost more than the second potential route (i.e., $150 vs. $120), route generator module 116 will select the first potential route. In some embodiments, for potential intermediate locations 506A-C and potential transportation segments 508A-G (of FIG. 5) having an associated time but not the actual cost, the user cost may be equal to weight time×(1/‘handler approval’ %). For potential intermediate locations 506A-C and potential transportation segments 508A-G (of FIG. 5) having an associated time and actual cost, the user cost may be equal to ((weight time+(actual cost×(‘cost per interval of time’ or ‘time per monetary unit’)))×(1/‘handler approval’ %)).

Further, for the recommended route, route generator module 116 may also consider a likelihood of approval of potential transportation segments 508A-G (of FIG. 5) by a handler (“handler approval”). As will be described in more detail, handler approval is required for each route. Accordingly, upon determination of a route, the handler may then review the route and either approve or deny all of it or segments of it. Thus, if the route is approved or denied, all segments in the route are marked “good” or “bad” However, if changed, the unchanged segments are marked “good” and the changed segments are marked “bad.” For example, if a user has previously submitted user requests and a particular segment has historically been approved for the user, the path search algorithm (e.g., A*) will likely prefer the particular segment. However, if a particular user has not previously submitted user requests, the likelihood of approval for a particular segment for the particular user may be based on other users. For example, if the particular user is requesting transport of a good similar to other transporters where the particular segment was approved, the likelihood of approval for the particular segment may be high. However, if the particular user is requesting transport of a good different from other transporters where the particular segment was not approved, the likelihood approval for the particular segment may be low. By operating in such a fashion, route generator module 116 may accurately consider different potential legs and routes that have different times and costs as preferred by the user.

After deriving the transit cost for each segment of the path, irrespective of user-selected service type 218 (of FIG. 2), route generator module 116 may utilize a path-finding algorithm to find a preferred route-having one or more segments-among the plurality of potential routes having a lowest cost (e.g., transit cost). In some embodiments, the path-finding algorithm may be A*, although other path-finding algorithms may be utilized.

Additionally, route generator module 116 may receive updates from transporter provider 104 on the delay of scheduled transports (e.g., flights, trains, buses). Likewise, route generator module 116 may receive updates from geographical provider 106 relating to drive-only transportation (e.g., traffic, road closure, accidents). In some embodiments, route generator module 116 may receive the updates in real-time. Accordingly, route generator module 116 may update the preferred route based on the service type 218 (of FIG. 2) (e.g., fastest route) and/or the user-selected delivery date and time (e.g., Mar. 16, 2020, at 2:00 PM EST). Route generator module 116 may then utilize the path-finding algorithm to see if a new preferred path exists.

When determining the optimal route based on the user's preferences and the cost and time associated with each transportation segment, the quote generator module 118 generates a quote for the total cost and time traveled for each suggested route determined by the route generator module 116. Quote generator module 118 translates information from the geographical data module 112, the transporter provider 104, geographical provider 106, and route generator module 116 to generate a quote of the cost of each transportation segment along each suggested route. Quote generator module 118 first analyzes each node along the suggested route to determine which carriers are being utilized for the given route. With that information, the quote generator module 118 reviews information provided from the classification submodule 130 to determine which classification the parcel is under for each node. The classification of the parcel determines how the quote generator module 118 calculates the quote for the given route. For example, if the route was drive-only, a simple flat rate per mile calculation may be used to determine the cost of each transportation segment along the route, and the segment costs could be summed to produce the total route cost. However, this calculation becomes complex when multiple carrier types (planes, trains, and automobiles) are utilized along different transportation segments of the route. Further, the calculation becomes further complex through the use of different service lines within each carrier type (American Airlines, United Airlines, etc.). Each service provider has their own unique cost structure. With that, the quoting module 118 receives information from the classification submodule 130 to determine the carrier type, service provider, and parcel classification. If the quoting module recognizes that the parcel is a small parcel, a quote will be calculated based on the carrier's flat rate fees. The quoting module then calculates a price quote for the suggested route based on, but not limited to factors including parcel size, parcel weight, longest parcel dimension, requirement of special certifications, day of the week, time of day, time of month, whether or not the delivery falls within a holiday, the geographical area of the pickup and destination locations (including country, state, city, or specific location), distance of the location from the nearest metro area, type of vehicle required for transportation, the historical data of previous costs for previous routes, special flight rules depending on the classification of the parcel, and whether or not a route is international.

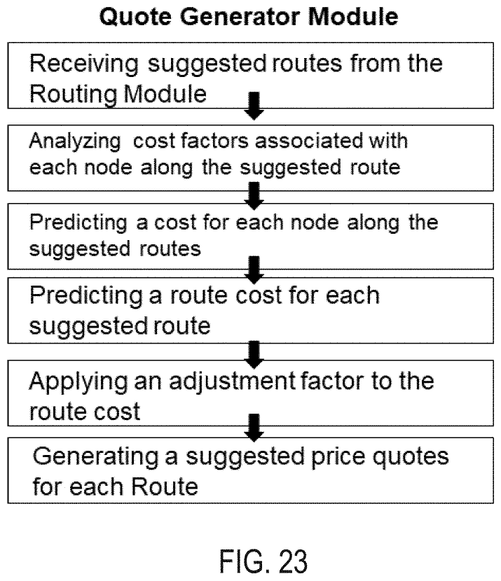

FIG. 23 illustrates a flow diagram describing the operation of the quote generator module in some embodiments. First, the quote generator module receives a plurality of potential or suggested routes from the route generator module. The routes provided by the route generator module can include multiple service carriers and multiple modes of transportation. The quote generator module individually analyzes cost factors associated with each node along the suggested routes. As described above, these factors relate to the specifications of the parcel, the requirements of the service carrier and mode of transportation being utilized, the timing, and the geographical area of the route. The quote generator module predicts segment costs for each transportation segment along the suggested routes. In some embodiments, the quote generator module utilizes a machine-learning model to more accurately predict future costs of new routes by analyzing availability of parcel space within cargo units of previous routes and factoring in previous re-routes that occurred at certain edges.

In some embodiments, routing module may further include a containment submodule 150 to group parcels into larger containers or box to reduce associated shipping costs. Containment module 150 translates information from the geographical data module 112, the transporter provider 104, geographical provider 106, and route generator module 116 to determine if a parcel can be grouped with another parcel during shipment to optimize cargo space and reduce associated shipment costs.

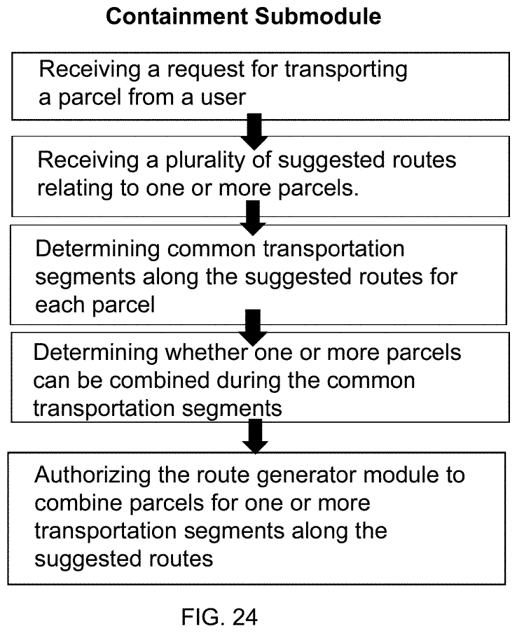

FIG. 24 illustrates a flow diagram describing the operation of the containment submodule 150 in some embodiments. First, the containment submodule receives a plurality of suggested routes from the route generator module relating to one or more parcels. Then, the containment submodule analyzes the pickup, intermediate, or destination locations for each parcel and for each suggested route to identify any common transportation segments along the suggested routes. If a common transportation segment is found, the containment submodule 150 analyzes the parcel information of the parcels that share the common transportation segment to determine if the parcels can be combined into a single shipping container. In some embodiments, the containment submodule analyzes factors including, parcel size, parcel shape, maximum parcel dimensions, parcel weight, parcel classification, container size, and mode of transportation. For example, in one embodiment, containment submodule may analyze two 12″ by 12″ square parcels and run a geometric simulation to determine whether or not the two parcels can fit within a 30″ by 30″ container. Such containment of the two parcels results in a cheaper shipping cost, a more efficient transportation system, and decreases the likelihood of a parcel being lost during transit. Once confirmed that the parcels can geometrically fit within the container and that the containment reduces shipping costs, the containment submodule authorizes the route generator module to combine parcels for one or more transportation segments along the suggested route. The parcels are separated and either combined with a different parcel going to a similar next location, or the parcels are individually shipped to their next location.

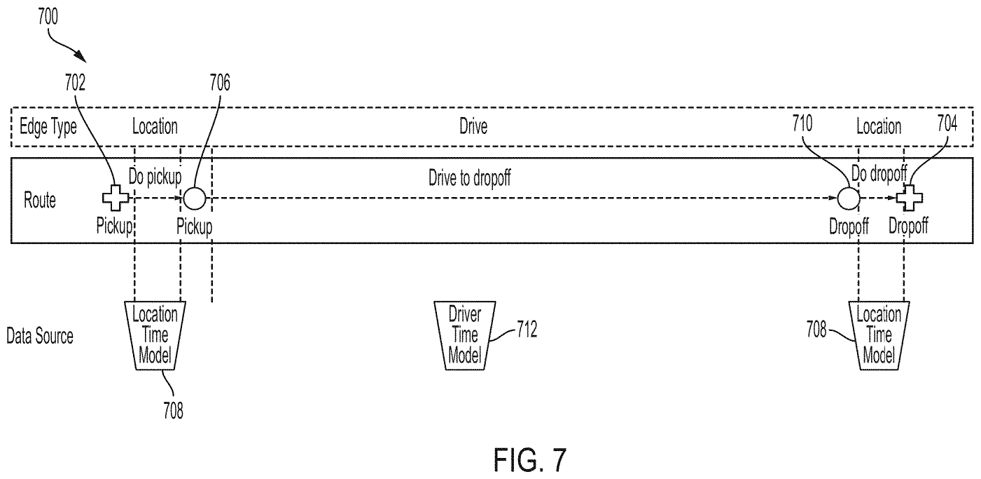

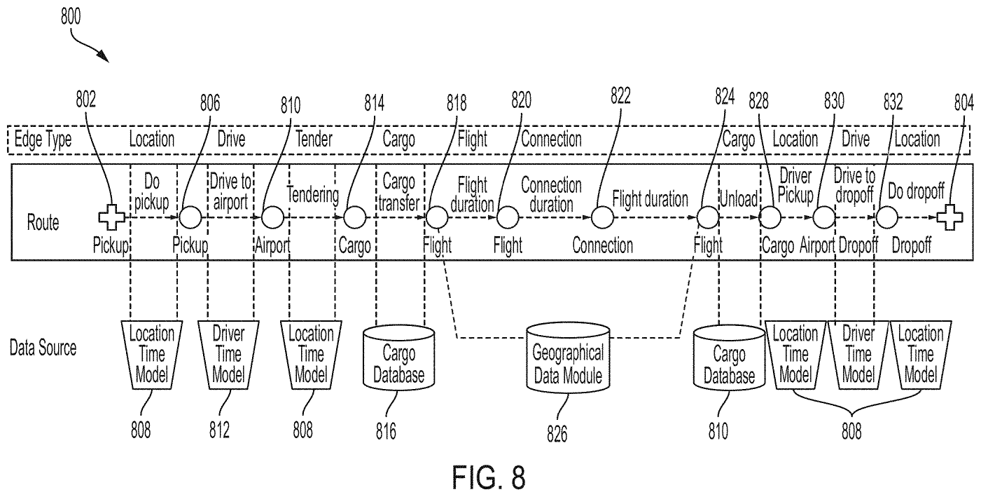

FIGS. 7 and 8 are example routes 700 and 800 from pickup location 702 and 802, respectively, to destination location 704 and 804, respectively. Example routes 700 and 800 are generated from geographical data module 112 and transporter module 118 (of FIG. 1). As described above, in some embodiments, as illustrated in FIG. 6, transporter module 600 includes transportation submodule 604, location submodule 602, and cargo submodule 606. Likewise, as also described above, in some embodiments, transportation submodule 604 and location submodule 602 includes transportation time model 610 and location time model 608, respectively.

FIG. 7 is an example drive-only route 700 from pickup location 702 to destination location 704. Location time models 708A and 708B determine a tendering time at pickup location 702 and at destination location 704, respectively. Driver time model 712, which is an example of a transportation time model, determines a travel time from pickup location 702 to destination location 704. As such, a transporter arrives at pickup location 702 and, after receiving goods, departs at time 706. Thereafter, the transporter arrives at destination location 704 at time point 710, and, after second amount of time, tenders goods.

FIG. 8 is an example of route 800 from pickup location 802 to destination location 804 via three intermediate locations: a first airport 806A, a second airport 806B, and a third airport 806C. Location time model 808A determines a tendering time at pickup location 802, location time model 808B determines a tendering time at the first airport 806A, location time model 808C determines a tendering time at the third airport 806C, and location time model 808D determines a tendering time at destination location 804. Specifically, location time model 808A determines a time to do a pickup at pickup location 802, location time model 808B determines a time to tender the goods to the first airport 806A, location time model 808C determines a time to remove the goods from cargo and ready them for pickup from the airport 806C, and location time model 808D determines a time required for the drop at the destination location 804. Cargo database 816A determines a time to transfer the goods to cargo at the first airport 806A, while cargo database 816B determines the flight a time for unloading at the third airport 816B. Geographical data model 826 determines the flight duration form the first airport 806A to the second airport 806B, the flight duration from the second airport 806B to the third airport 806C, and the time idle (i.e., layover duration) at the second airport 806B. Driver time model 812A and driver time model 812B are examples of transportation time models. Driver time model 812A determines a travel time from pickup location 802 to the first airport 806A, while driver time model 812B determines a travel time from the third airport 806C to destination location 804.

Accordingly, a transporter arrives at pickup location 802, receives goods, and departs at time point 803. The transporter then arrives at first intermediate location 806A (e.g., first airport) at time point 810. The goods are tendered until time point 814. The goods are then transferred via cargo until time point 818 so that they are ready for transport to second intermediate location 806B (e.g., second airport). Thereafter, the goods depart from first intermediate location 806A (e.g., first airport) to second intermediate location 806B (e.g., second airport) at time point 820.

After arriving at second intermediate location 806B (e.g., second airport), route 800 has a layover. As such, the goods depart from second intermediate location 806B (e.g., second airport) at time point 822, and arrive at third intermediate location 806C (e.g., third airport) at time point 824. Upon arriving at third intermediate location 806C (e.g., third airport), goods are transferred via cargo until time point 828 so that they are ready for pickup by a transporter for delivery to destination location 804. The transporter thus arrives at the third intermediate location 806C, receives the goods, and departs to the destination location 804 at time point 830. After arrival at destination location 804 at time point 832, transporter drops off the goods to an authorized individual.

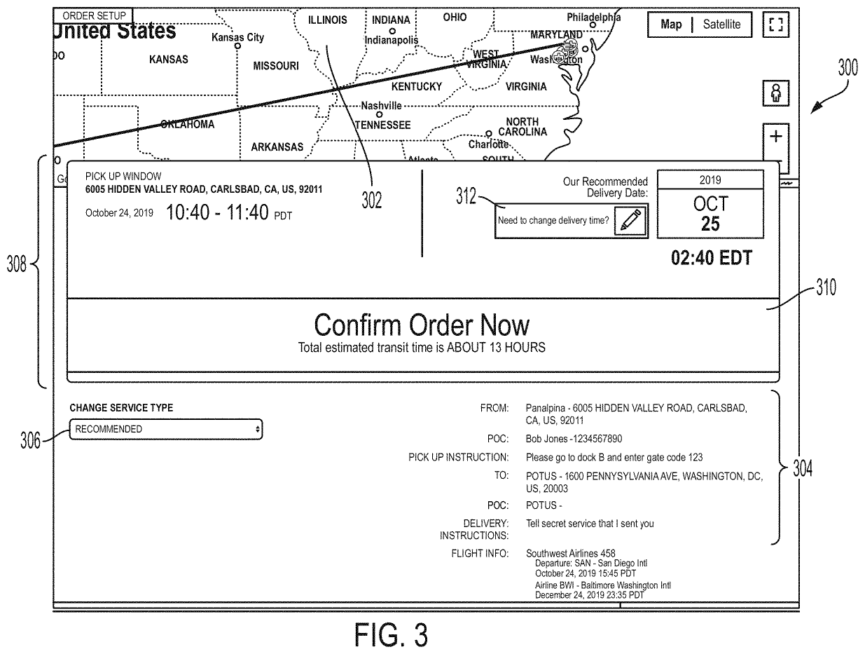

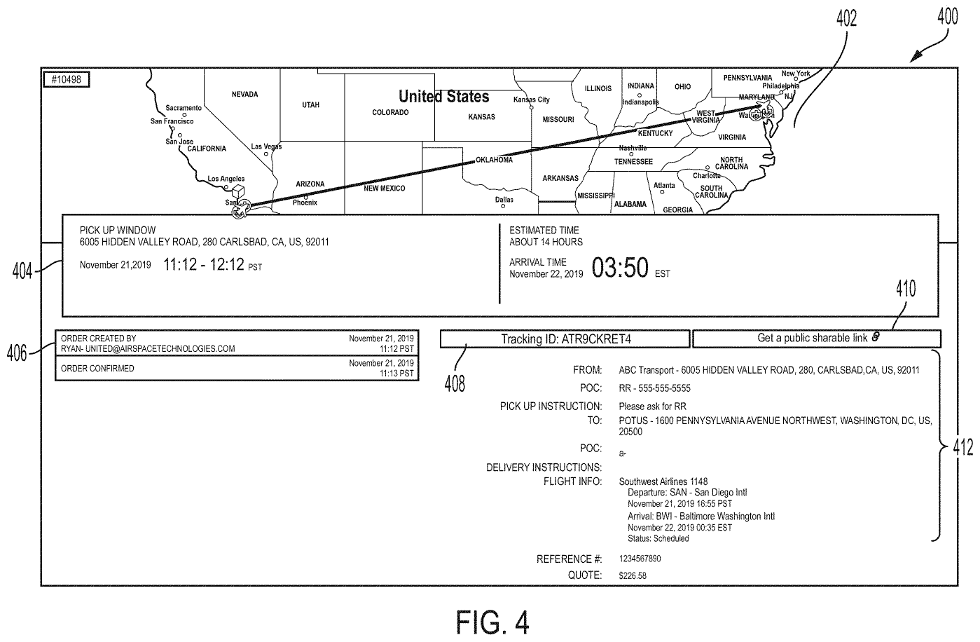

Referring back to FIG. 1, during and/or after the appropriate route from a pickup location to a destination location, transporter application 120 receives requests from transporters—via user devices 108A-C—for transporting goods from a pickup location to an intermediate location (e.g., an airport) or a destination location. As such, transporter application 120 may provide instructions to transporters via user devices 108A-C during their route, as will be discussed in more detail below. Accordingly, after the submission of an order of goods as described above with respect to FIGS. 1-4, transporter application 120 communicates with transporter module 118 to identify an appropriate transporter for transporting goods from the pickup location to the intermediate or destination locations.

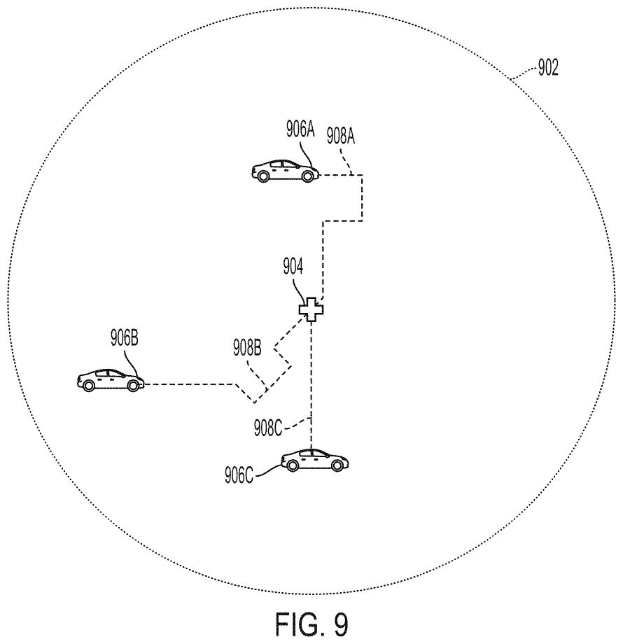

Referring now to FIG. 6, to identify the appropriate transporter, transporter module 600 further includes transporter submodule 616. After users submit orders, transporter submodule 616 identifies available transporters within a predetermined distance from the pickup location or intermediate, for example, by tracking their location through user devices 108A-C (of FIG. 1). The available transporters may be assigned to another job. In other words, the available transporters may have picked up or be scheduled to pick up goods for another job from a different or same pickup location. Likewise, the available transporters may be scheduled to transport goods for another to a different or same intermediate or destination location. FIG. 9 illustrates example available transporters 906A-C within predetermined distance 902 from pickup location (or intermediate location) 904.

Referring to FIG. 6, transporter submodule 616 may then determine if the number of identified available transporter meets or exceeds a predetermined number of available transporters. Transporters may relate to an individual or a carrier. In some embodiments, if the number of identified available transporters does not meet or exceed a predetermined number of drivers, transporter submodule 616 may expand the searchable range by a predetermined distance. Alternatively, if the number of identified available transporters does not meet or exceed a predetermined number of available transporters, transporter submodule 616 may expand the searchable range until the predetermined number of available transporters is met. The predetermined distance may be 5 miles, 10 miles, 19 miles, or 50 miles, to provide a few examples. The predetermined number of available transporters may be 5, 10, 15, or 20, to provide a few examples.

Transporter submodule 616 may then identify eligible transporters for transporting the goods from the available transporters. As discussed above, the goods may require special handling by the transporters. For example, the goods may be fragile (e.g., glass) or an organ (e.g., a heart). Further, the goods may be heavy (e.g., furniture) or need refrigeration (e.g., produce and human tissue) and thus require special transportation. Likewise, the goods may be of a certain size (e.g., a car) and thus need a suitable size carrier. As such, transporter submodule 616 may ensure that the available transporters have the appropriate certifications and/or are of the appropriate kind of carriers (e.g., a vehicle or a truck). Thus, transporter submodule 616 may filter through the available transporters for eligible transporters, for example, those that have the proper certification and/or are of the appropriate type of carriers. Transporter submodule 616 may then determine if the number of eligible transporters meets or exceed a predetermined number of eligible transporters. If not, as discussed above, the searchable range is expanded by a predetermined distance or until the predetermined number of eligible transporters is met.

Transporter submodule 616 may then determine if the eligible transporters are solicitable. Eligible transporters are solicitable if they are able to transport the good to the pickup location, intermediate location, or destination location by a time specified by route generator module 116 (of FIG. 1) or a user in the request. Further, as mentioned above, eligible transporters may include those transporting or scheduled to transport other orders. Accordingly, these eligible transporters are solicitable if they are, or will be, going to the same pickup location, intermediate location, or destination location. Further, eligible transporters assigned other jobs are solicitable if they can complete transport all jobs by their specified times.

Accordingly, to identify solicitable transporters, transporter submodule 616 determines an Estimate Completion Time (ECT) for completing transport of all jobs for each eligible transporter. As such, for an eligible transporter not transporting any other orders, transporter submodule 616 determines an ECT for a transporter to pick up and deliver the solicited order. For an eligible transporter transporting other orders, transporter submodule 616 determines an ECT for a transporter to pick up the orders from the pickup location and deliver the orders to the intermediate and destination locations in any sequence. To determine the ECT, transporter module 600 can utilize a trained transporter model.

To determine the ECT, transporter submodule 616 can utilize a trained transporter model. In some embodiments, the trained transporter model can include transportation submodule 604's transportation time model 610 and/or location submodule 602's location time model 608. As discussed above, transportation time model 610 determines an estimated amount of time for transporters to transport the goods to the pickup and/or intermediate locations (“an estimated transport time”). Accordingly, as illustrated in FIG. 9, transportation time model 610 (of FIG. 6) may determine particular routes 908A-C for transporters 906A-C to travel to pickup location or intermediate location 906. Location time model 608 determines an estimated amount of time for transporters to tender the goods at pickup and/or intermediate locations (“an estimated tender time”).

In some embodiments, transporter submodule 616's trained transporter model can also include transporter acceptance time model 618 and transporter acceptance chance model 620. Transporter acceptance time model 618 predicts an estimated amount of time that it will take a transporter to accept a solicitation for a job (“an estimated transporter acceptance time”). In some embodiments, transporter acceptance time model 618 may be based on a predetermined time provided to solicited transporters (e.g., 90 seconds). In some embodiments, transporter acceptance time model 618 is based on an output provided by transporter acceptance chance model 620, which may represent a likelihood of a particular solicitable transporter accepting the job. In some embodiments, solicitation acceptance time may be equal to a predetermined solicit time×(1/a likelihood of solicitable transporter acceptance). In some embodiments, transporter acceptance chance model 620 may include a location and time-based machine-learning model be trained on historical data of the particular solicitable transporter accepting previous jobs, for example, at certain hours of the day.

Therefore, the ECT may be a total of an estimated tender time, an estimated transport time, and/or an estimated solicitation acceptance time. Along these lines, where the solicitable transporter is scheduled to transport multiple jobs, transporter submodule 616 may derive the ECT for completing transport for picking up and delivering orders to the destination or intermediate locations in every potential sequence. After doing so, transporter application 120 selects the sequence of events having the least amount of time to represent the time the solicitable transporter may perform the jobs.

For example, if the solicitable transporter was previously assigned “jobA” and is currently being solicited for “jobB,” transporter submodule 616 may determine an ECT for each of the following sequences—(i) picking up “jobA,” picking up “jobB,” delivering “jobA,” and delivering “jobB,” (ii) picking up “jobA,” picking up “jobB,” delivering “jobB,” and delivering “jobA,” (iii) picking up “jobA,” delivering “jobA,” picking up “jobB,” and delivering “jobB,” (iv) picking up “jobB,” picking up “jobA,” delivering “jobA,” and delivering “jobB,” (v) picking up “jobB,” picking up “jobA,” delivering “jobB,” and delivering “jobA,” and (vi) picking up “jobB,” delivering “jobB,” picking up “jobA,” and delivering “jobA.” Accordingly, if the ECT for sequences (i), (ii), (iii), (iv), (v), and (vi) is 120 minutes, 170 minutes, 130 minutes, 90 minutes, and 160 minutes, respectively, transporter application 120 may select sequence (iii) as representing the transporter for the amount of time it can complete “jobA” and “jobB.”

Along these lines, to compare multiple solicitable transporters previously assigned other jobs, transporter submodule 616 may select the solicitable transporter having the shortest ECT for completing the solicited offer. For example, solicitable transporters “X” and “Y” may have been previously assigned “jobA” and “jobB,” respectively, and are currently being solicited “jobC.” As such, transporter submodule 616 may determine that transporter “X” 's ECT for completing “jobA” and “jobC” is 120 minutes, and that transporter “Y” 's ECT for completing “jobB” and “jobC” is 180 minutes. In some embodiments, transporter submodule 616 may determine that transporter “X” 's and “Y” 's ECT for completing “jobC” is 70 minutes and 90 minutes, respectively. Accordingly, although transporter “X” 's ECT for completing both jobs is shorter than transporter “Y” 's ECT, transporter submodule 616 may select transporter “Y” since transporter “Y” ECT for completing the transport of the solicited job—i.e., “jobC”—is shorter. In some embodiments, transporter submodule 616 may determine that transporter “X” 's and “Y” 's ECT for completing “jobA” is 120 minutes and 90 minutes, respectively. Transporter submodule 616 may also determine that the transporter “X” is to complete “jobA” then “jobB” and that transporter “Y” is to complete “jobB” then “jobA.” Accordingly, although transporter “Y” is to complete “jobB” after a previously assigned order, transporter “Y” may still be selected over transporter “X.”

Along these, transporter submodule 616 may consider solicitable transporters previously assigned other orders and solicitable transporters not previously assigned other orders. Transporter submodule 616 may then select the solicitable transporter having the least ECT for completing transport of the solicited job as a preferred pickup transporter. For example, transporter submodule 616 may consider transporters “A” and “B.” Transporter “A” may have been previously assigned “jobA” and is being solicited for “jobB.” Transporter B is only being solicited for “jobB.” Accordingly, transporter submodule 616 may determine that the ECT for transporters “A” and “B” for completing solicited offer “job” is 80 minutes and 100 minutes, respectively. As such, transporter submodule 616 may select transporter “A,” although it has been assigned another job (i.e., “jobA”) and may deliver the other before the solicited job (i.e., “jobB”).

Transporter submodule 616 may then send a request to the preferred transporter to transport the order. In some embodiments, transporter submodule 616 may wait a predetermined amount of time (e.g., 90 seconds) for acceptance. If the solicited transporter does not accept the offer, transporter submodule 616 may then restart the process to determine an appropriate transporter (i.e., identify available transporters, identify eligible transporters from the available transporters, etc.). In doing so, the transporter may be considered again for solicitation, albeit the acceptance chance model may derive a lower likelihood of accepting the job based on their lack of acceptance previously, thus being less likely to be solicited again.

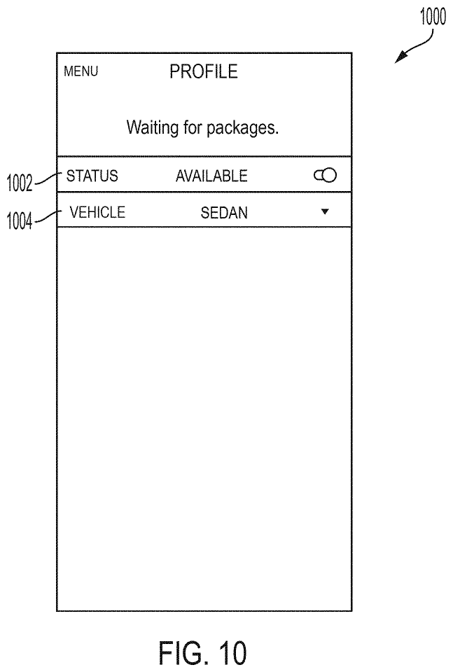

FIGS. 10-21 illustrate example user interfaces 1000, 1100, 1200, 1300, 1400, 1500 and 1600 of a transporter application 120 (of FIG. 1), according to some embodiments. Referring now to FIG. 10, user interface 1000 may include status indicator 1002 and/or vehicle type 1004. Status indicator 1002 may permit a transporter to indicate availability for the transporting of goods. In some embodiments, status indicator 1002 may permit date and/or time for which the transporter will be available. Vehicle type 1004 may permit a transporter to provide vehicle information for which the transporter will deliver goods. The vehicle information may include a year, a make, a model, and any other type of special handling (e.g., refrigeration). In some embodiments, user interface 1000 may receive notifications of solicitation of a job. Notification includes a pickup time and/or date and an option to “view” or “dismiss” the job. If the “view” option is selected, the user approves the job. However, if the “dismiss” option is selected, the user rejects the job.

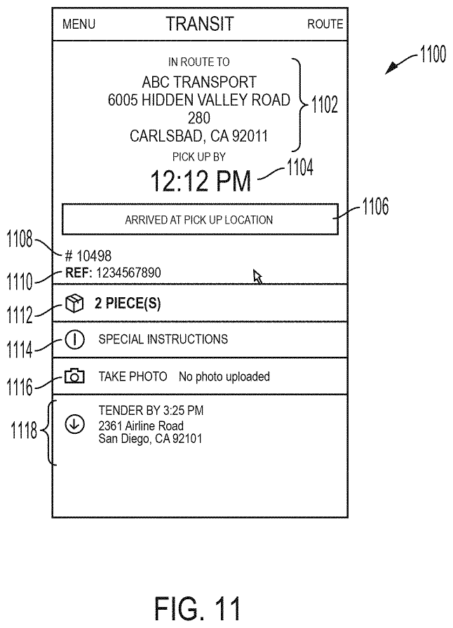

Referring now to FIGS. 11, upon viewing (or approving) a particular job, user interfaces 1100 may be presented. FIG. 11 illustrates user interface 1100 including special instructions notification 1114 of the job. In some embodiments, special instructions notification 1114 may be provided before viewing of the details of the job. As noted above, the special instructions may be provided by a user when submitting a request, or, as will be discussed in more detail below, by an authorized user in processing the request. This confirms that the transporter views the special instructions. FIG. 11 illustrates user interface 1100 providing details of the job for the transporter. User interface 1100 includes pickup location 1102, pickup time 1104, arrival button 1106, order number 1108, reference number 1110, goods information 1112, special instructions 1114, take photo option 1116, and/or tender information 1118. Pickup location 1102 may be a current location of goods. Pickup time 1104 may be a required amount of time for the transporter to arrive at arrival location 1102. In some embodiments, pickup time 1104 may be based on traffic and available routes received from geographical provider 106 (of FIG. 1). Further, pickup time 1104 may be no greater than a predetermined amount of time (e.g., one hour). This may be important for time-critical shipment of goods (e.g., a heart). Arrival button 1106 permits transporters to indicate arrival at the pickup location. Order number 1108 may be an internal number for reference by authorized users and/or for processing by central server 102 (of FIG. 1). Reference number 1110 may be an external number for client use. Goods information 1312 permits transporters to view data relating to the goods. Good information may include a number of packages, size of the packages, weight of the packages, classification of the packages, a tracking number, and identification information, to provide a few examples. Take photo option 1116 permits transporters to take photos of goods. Upon receipt of photos, central server 102 may determine if the goods are the appropriate goods for transport. Tender information 1118 permits transporters to view any information relating to a location for tendering the goods. As illustrated, in some embodiments, tender information 1118 may include a tender time and/or location. As noted above, transporters may not be aware of particulars of a job, such as a tender location, until acceptance of the job.

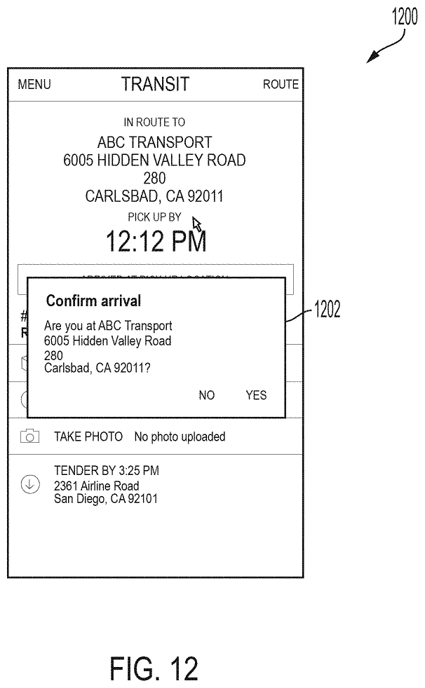

Referring now to FIG. 12, upon arrival to a designated location (e.g., pickup location or intermediate location), prompt 1202 may be provided. As such, prompt 1202 may be automatically provided upon user device 108A (of FIG. 1) (e.g., a mobile device) detecting the presence of transporter at the designated location via location tracking of user transporter device 108A through transporter application 120 (of FIG. 1). Prompt 1202 may confirm that the transporter is at the designated location.

Upon confirming arrival via prompt 1202 (of FIG. 12), user interface 1300 may be provided. Like user interface 1100, user interface 1300 provides arrival location 1302, pickup time 1304, order number 1306, reference number 1308, goods information 1310, special instructions 1312, take photo 1314, and/or tender information 1316. User interface 1300 may also present next step option 1318 and/or waiting option 1320. Next step option 1318 may be selected when the goods are ready for transport and/or received by the transporter. In some embodiments, next step option 1318 may not be selected until the transporter application 120 (of FIG. 1) confirms the transporter is at the pickup location. The confirmation may be accomplished by tracking a location of transporter's user device 108A (of FIG. 1) and/or receiving an indication from the designated location. Waiting option 1320 may be selected when the goods are not ready for transport.

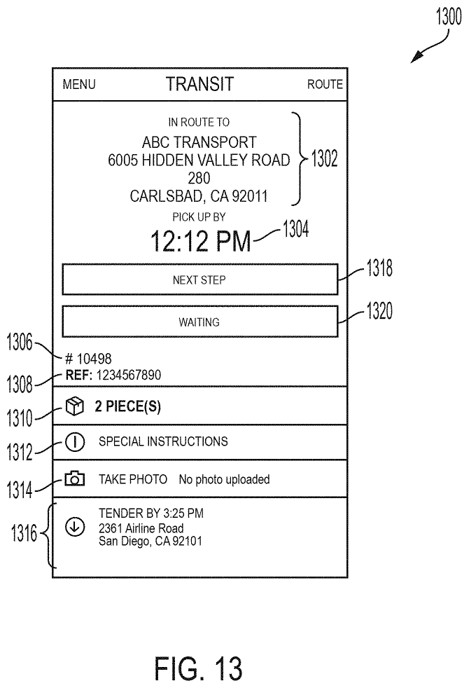

Upon selection of waiting option 1320 (of FIG. 13), user interface 1300 tracks a waiting time at the designated location for the transporter to receive the goods. In some embodiments, when the transporter waits predetermined amounts of time (e.g., fifteen minutes), the transporter is to receive a predetermined additional amount of money.

After selecting user interface 1300's next step option 1318, transporter may be prompted to enter a unique package number (e.g., an order number), take a picture of a code, and/or scanning a code via user device 108A (of FIG. 1). Thereafter, user interface 1300 may provide goods information. Upon doing so, central server 102 (of FIG. 1) may verify that the transporter is picking up the correct package. Subsequently, transporter application 120 (of FIG. 1) may require receiving a name and/or signature of an authorized receiver at the pickup location via user device 108A.

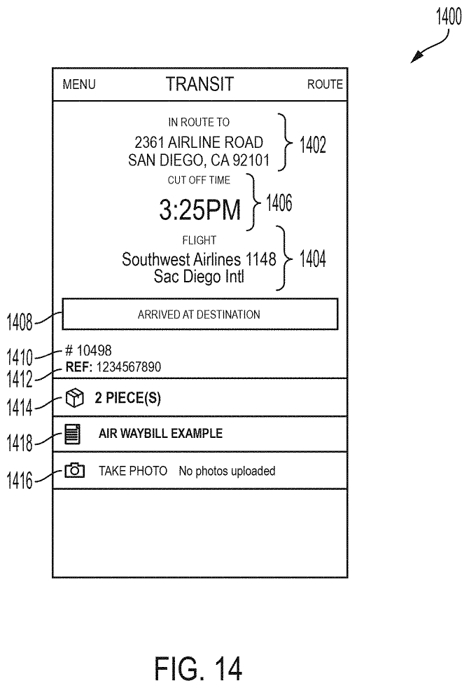

Referring now to FIG. 14, after the goods are verified, user interface 1400 may be provided. User interface 1400 may provide information for transporting the picked up goods to the tender location (e.g., an intermediate location or a destination location). User interface 1400 may also include tender location 1402, transport information 1404, cutoff time 1406, and/or arrival button 1408. Tender location 1402 is an intermediate or destination location. When the tender location 1402 is an intermediate location, transport information 1404 may provide transport information for the transport of the goods from the intermediate location to the next intermediate location or the destination location. For example, as illustrated, transport information 1404 may include a flight transporting the goods. Along these lines, cutoff time 1406 may be the latest time at tender location 1402 for receipt goods. As such, cutoff time 1406 may be based on transport information. For example, if a flight is delayed, cutoff time 1406 may be adjusted accordingly. Arrival button 1408 may provide an indication that the transporter has arrived at the tender location.

User interface 1400 may also include order number 1410, reference number 1412, good information 1414, and/or take photo 1416. User interface 1400 may further include air waybill example 1418. As indicated above, transporters may tender goods to an intermediate location for further transport by a transportation company utilizing a mode of transportation. The intermediate location, the transportation company, or the mode of transportation may require a unique transport bill. For example, Delta Airlines, United Parcel Service, and United Airlines may all have different transport bills. As such, air waybill example 1418 may assist the transporter in accurately completing unique transport bills at the tender location so that there are no issues in tendering the goods.

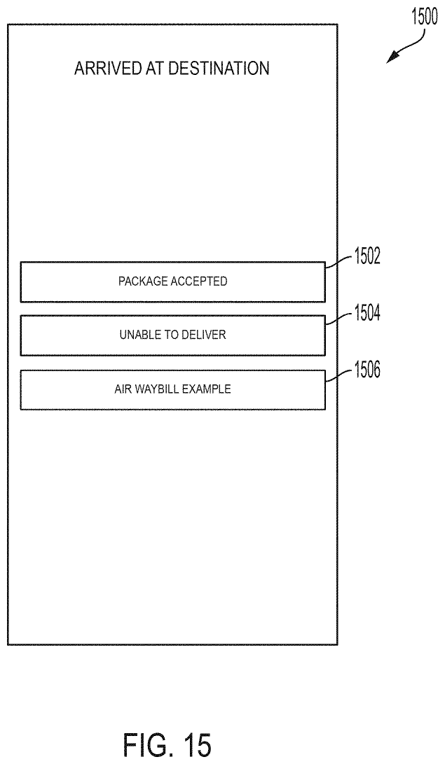

Referring now to FIG. 15, after verification by the central server 102 (of FIG. 1), user interface 1500 may be provided. User interface 1500 may include package accepted button 1502, unable to deliver button 1504, and/or air waybill example button 1506. Upon indicating the package is accepted via package accepted button 1502, the transporter may be required to enter an airway bill number and/or provide a picture of the airway bill.

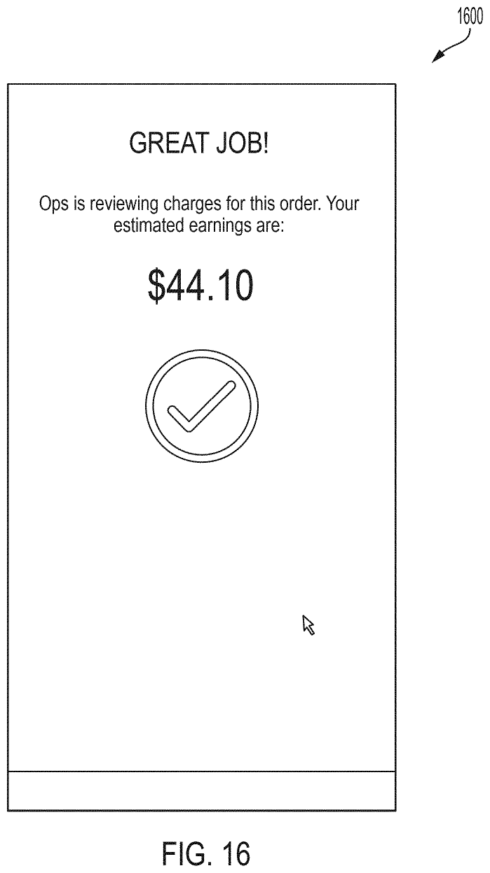

Referring now to FIG. 16, after tendering the package at the tender location, user interface 1600 may be provided. User interface 1600 may provide a transporter with the reward. As illustrated, the reward may be an amount of money. However, the reward may also be a number of points or any other type of token for service. As such, transporters may not be aware of their reward until after tendering the goods at the tender location or attempting to do so. Further, as explained above, the reward may be based on their waiting times at the pickup location and/or tender location. Further, the reward may be based on the length of the trip, the time duration of the trip, and/or the importance of the goods. Along these lines, the reward may be reduced if the transporter does not arrive at the pickup and/or dispatch location by the specified time.

Referring back to FIG. 1, transport manager application 122 permits authorized users—via user devices 108A-C—to track and/or manage orders for the transport of goods. Accordingly, upon submission of an order as described with respect to FIGS. 2-4, transport manager application 122 may receive an order for the transport of goods. Transport manager application 122 may assign the order to a predetermined order type based on the type of goods and/or the mode of transportation. For example, some goods require special handling (e.g., refrigeration, chemicals, body parts), whereas other orders may be of a special type (e.g., healthcare orders or medical orders). Accordingly, by assigning the order to an appropriate order type, transport manager application 122 may ensure that an appropriate operational team member (e.g., handler)—having the requisite skill and knowledge—to monitor the transport of the order.

In some embodiments, transport manager application 122 may assign the appropriate operational team members to the orders. Alternatively, transport manager application 122 may allow the appropriate operational team member to select an order to monitor. Along these lines, multiple operational team members may work on orders during transport of the goods from the pickup location to the destination location.

Further, in some embodiments, transport manager application 122 may receive preferred routes from route generator module 116. Transport manager application 122 may also permit appropriate operational team members to approve, create, and/or modify determined preferred routes. Further, transport manager application 122 may permit appropriate operational team members to assign transporters for the transport of the order. Similarly, transporter manager application 122 may permit authorized users to assign tasks to transporters. In doing so, transporter manager application 122 may provide transporters an amount of money for completing or attempting to complete the assigned tasks.

Further, to monitor the transport of orders, transport manager application 122 may receive updates from the transporters on the status of the transport. In some embodiments, transport manager application 122 may receive updates from transport provider 104 on the delay of scheduled transports (e.g., flights, trains, buses). Likewise, in some embodiments, transport manager application 122 may receive updates from geographical provider 106 relating to drive-only transportation (e.g., traffic, road closure, accidents). Further, in some embodiments, transport manager application 122 may receive updates from the transporters-via user devices 108A-C-scheduled to pick up goods from the pickup and/or intermediate locations. For example, the transporters may not have been departed to and/or from the pickup and/or intermediate locations by the designated time. Accordingly, in some embodiments, transport manager application 122 may receive updates from transport provider 104, geographical provider 106, and/or user devices 108A-C in real-time.

By operating in such a fashion, transport manager application 122 may permit appropriate operational team members to monitor orders during their transport. In doing so, in some embodiments, transport manager application 122 may assign scheduled actions to the orders. Transport manager application 122 may also receive scheduled actions for the orders from the appropriate operational team members. Scheduled actions may relate to a required operation from a transporter departing to, arriving at, and/or departing from a pickup location, an intermediate location, and/or destination location. As such, in some embodiments, the scheduled actions may relate to a specific time. Accordingly, transport manager application 122 may sort the orders based on their upcoming time and assign them a color based thereon (e.g., green, yellow, and red).

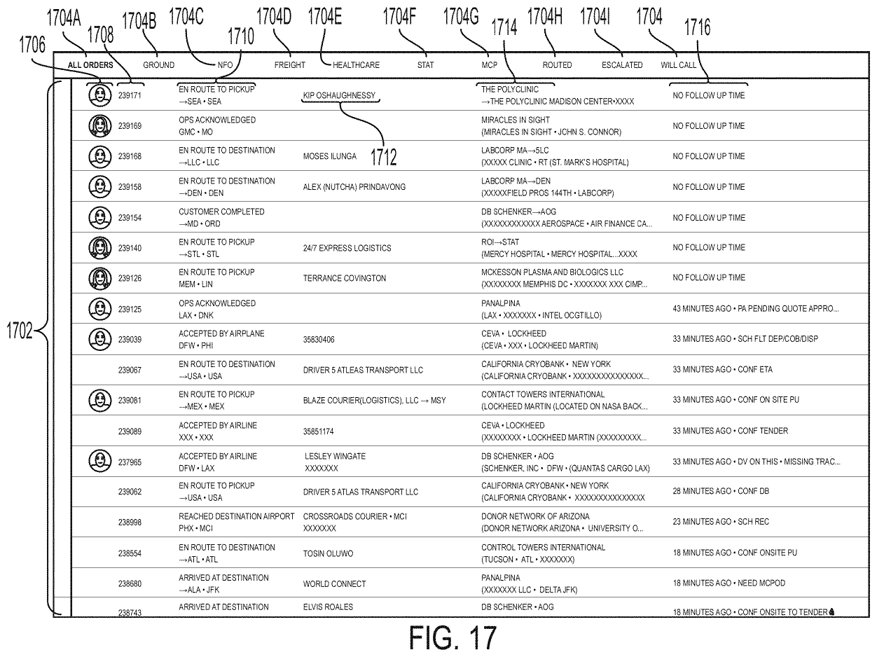

FIGS. 17-20 illustrate user interfaces 1700, 1800, 1900, and 2000 provided by transport manager application 122 (of FIG. 1). FIG. 17 illustrates user interface 1700 for tracking orders 1702 in real-time. User interface 1700 provides order types 1704A-J and allows handlers to select and view orders of the different order types 1704A-J. Each order type 1704A-J may require different handling and/or skill. As such, operational teams may be trained to manage and/or handle different groups of order types 1704A-J. As such, operational team members (e.g., handlers) may select or be assigned orders.

As illustrated, order types 1704A-J may include all orders 1704A, ground orders 1704B, next flight out (NFO) orders 1704C, freight orders 1704D, healthcare orders 1704E, immediate (STAT) orders 1704F, medical collection (MCP) orders 1704G, routed orders 1704H escalated orders 1704I, and/or will call orders 1704J. All orders 1704A may relate all orders currently being processed. As such, all orders 1704A includes ground orders 1704B, NFO orders 1704C, freight orders 1704D, healthcare orders 1704E, STAT orders 1704F, MCP orders 1704G, routed orders 1704H, and/or escalated orders 1704I. Ground orders 1704B relates to orders of goods being transported by ground. As such, ground order 1704B relates to orders of goods whose routes do not have a segment and have a mode of transportation other than ground (e.g., a flight segment). NFO orders 1704C relates to orders of goods to be transported by flight and not requiring special handling. Freight orders 1704D relate to orders of goods needing special handling. For example, freight orders 1704D may be above a predetermined weight (e.g., 100 lbs.), greater than a predetermined dimension (e.g., 5 FT×5 FT×5 FT), call for a controlled temperature (e.g., less than 29° F.), and require secure shipment, to provide a few examples.

Healthcare orders 1704E may relate to orders of healthcare goods, which may or may not require special handling. STAT orders 1704F may relate to goods to be transported at predefined times (e.g., 8:00 AM and 4:00 PM) and/or places (e.g., hospitals, doctor offices, and pharmacies). MCP orders 1740G relate to orders of goods that require skill by transporters. In some embodiments, for example, the packages may contain blood or a bodily tissue. Routed orders 1704H relates to orders having predetermined routes required to be followed by transporters. For example, where the transporter has multiple orders and must pick up one order or drop one order off in a particular sequence, the orders may be considered routed orders 1704H. Escalated order 1704I relates to any order manually escalated by an authorized user. As such, escalated order 1704I may include ground orders 1704B, NFO orders 1704C, freight orders 1704D, healthcare orders 1704E, STAT orders 1704F, MCP orders 1704G, and/or routed orders 1704H. Will call orders 1704J may be orders of goods submitted via will call by users, as described above with respect to FIG. 2. Will call orders 1704J are not active orders 1704A.

User interface 1700 presents all orders 1702 categorized under all orders group 1704A. For each order 1702, user interface 1700 provides handler 1706, order number 1708, status indicator 1710, current transporter 1712, target location 1714, and/or scheduled action 1716. Handler 1706 may be individual or member of the appropriate operational team in charge of the order of goods. Order number 1708 may be a unique alphanumeric number generated by central server 102 (of FIG. 1) for the order. Status indicator 1710 may provide an indication of where the goods are in the route generated by central server 102. For example, the goods may be at a pickup location, in transport to an intermediate location, at an intermediate location, in transport to a destination location, and/or at a destination location. Current transporter 1712 may refer to a specific transporter transporting the good at a particular time. Target location 1714 may refer to a current pickup location, intermediate location, or delivery location being traveled to by the transporter currently transporting the good. Scheduled action 1716 may be a follow-up action provided by handler 1706. The follow-up action may specify a desired time to perform the action.

In some embodiments, although not illustrated, orders 1702 may be designated a predetermined color based on a transportation status, and/or status action. The transportation status may relate to a departure time, pickup time, a tender time, or the parcel classification. As discussed above, the transporter may be required to depart from their current location or an intermediate location at a specific departure time. Likewise, the transporter may be required to pick up goods at a pickup location at a specific pick up time. Further, the transporter may be required to tender the package at an intermediate location (e.g., an airport) at a specific tender time. As such, the orders 1702 may change colors based on the transportation status. In some embodiments, the predetermined colors may be red, yellow, or green. The designated color may be selected based on predetermined rules. For example, an order of goods may be green until reaching a predefined threshold and thereafter change to yellow. Thereafter, after reaching another predefined threshold, the order of goods may change to red. This may allow assigned handlers or other authorized users to track the orders of goods.

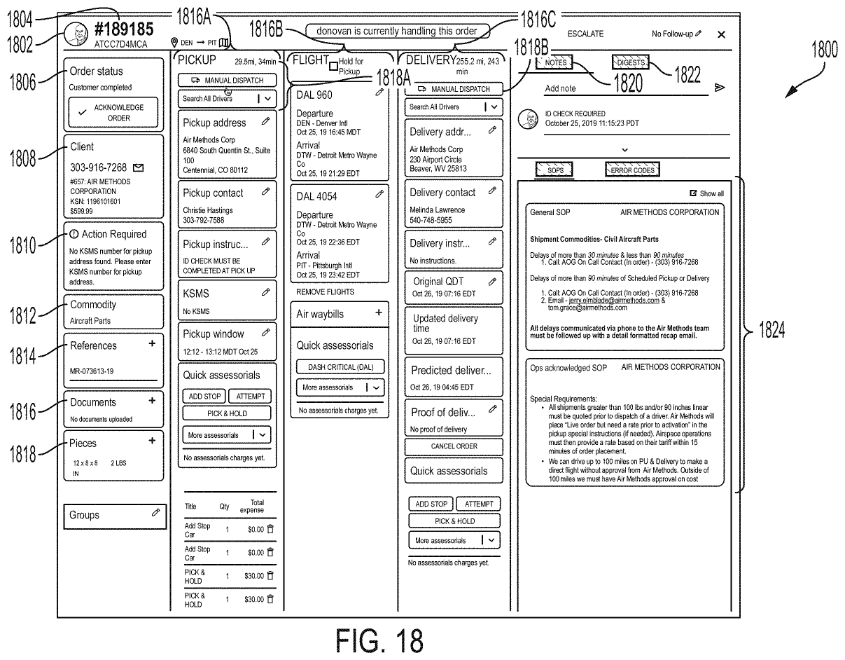

Referring now to FIG. 18, after the selection of a particular order 1702 (of FIG. 17) by a handler, user interface 1800 may be presented. User interface 1800 may include assigned handler 1802, order number 1804, order status 1806, user information 1808, actions required 1810, commodity type 1812, reference number 1814, attached documents 1816, and/or goods information 1818. Order status 1806 may be updated in real-time and be one of a predetermined number of events, such as those illustrated status indicator 1810 (of FIG. 17). User information 1808 may include contact information of a user requesting the transport of goods. Actions required 1810 may include actions required by a handler. Commodity type 1812 may relate to a good type. Reference number 1814 may be a tracking number for a particular package of goods of the order being transported. In some embodiments, an order may include multiple packages having different tracking numbers. Attached documents 1816 may be documents relating to the transport of the goods and may be uploaded by the transporter (e.g., airway bill) and/or handler (e.g., airway bill example). As such, user information 1808, commodity type 1812, and/or goods information 1818 may be provided via a user request at user interface 200 (of FIG. 2).

User interface 1800 may also include segment information 1816A-C for segments of a route from a pickup location to a destination location. In some embodiments, as illustrated, segment information 1816A relates to picking up the goods, segment information 1816B relates to tendering the goods at an intermediate location (e.g., an airport), and/or segment information 1816C relates to delivering the goods to a drop off location. As such, segment information 1816A includes transporter information (e.g., a name, a license plate, and/or a type of vehicle), a pickup address, a pickup contact, pickup instructions, a pickup window, and/or assessorials. Segment information 1816B includes information of the intermediate location. For example, when the intermediate location is an airport, segment information 1816B may include flight information (e.g., departure time, arrival time, departure location, arrival location, and flight number), and airway bills. Segment information 1816C includes a transporter delivery address, a delivery contract, delivery instructions, an original quoted delivery time, an updated delivery time, a proof of delivery, and assessorials.

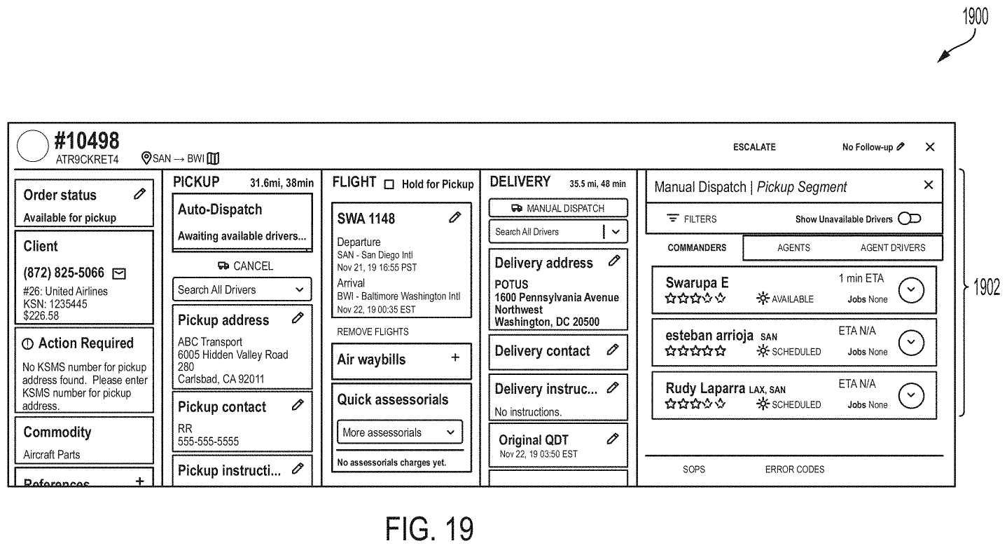

As stated above, segment information 1816A and 1816C may include transporter information. In some embodiments, as described above, upon submission of orders by users, the central server 102 (of FIG. 1) may automatically select the appropriate transporter. Segment information 1816A and 1816C may also permit members to manually dispatch transporters 1818A and 1818B. As such, referring now to FIG. 19, eligible and ineligible transporters 1902 may be provided. For each transporter 1902, user interface 1900 may provide a rating, an availability, and/or an estimated time of arrival.

Referring back to FIG. 18, via assessorials, segment information 1816A and 1816C permits assigned handlers to provide or select tasks (e.g., picking up dry ice for medication and/or printing documents) for transporters of goods. The handlers may reward the transporters for performing the tasking or attempting to do so, for example, by providing them a selected or predetermined amount of money. As explained above, the reward amount may be unknown to the transporter until completion of the transport.

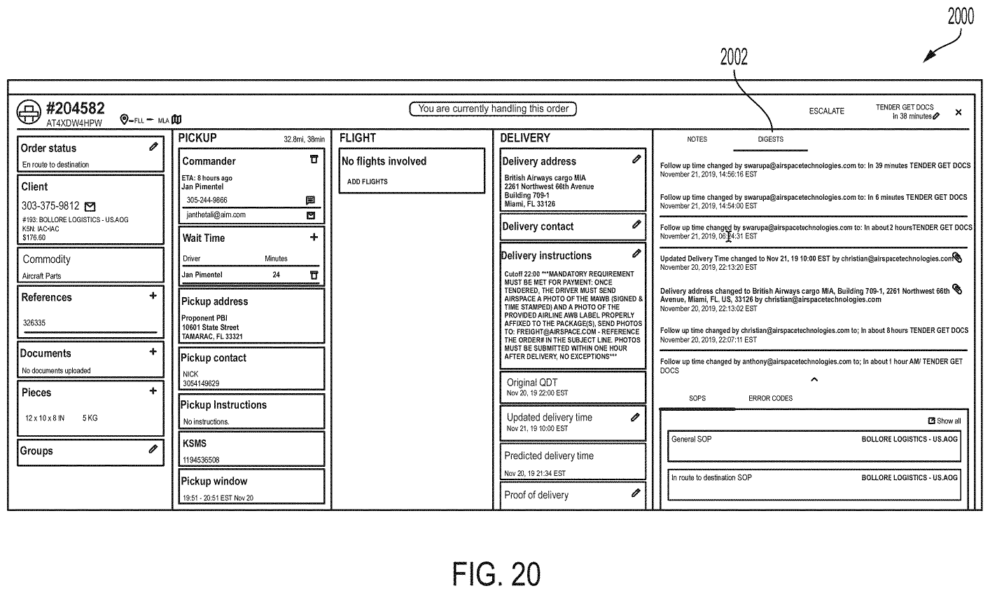

User interface 1800 may permit handlers to provide notes 1820, digest 1822, and/or special operational instructions (SOP) 1824. Notes 1820 may be provided by handlers for themselves or future handles. Digest 1822 may be automatically generated by transport manager application 122 (of FIG. 1) in real-time and may include a particular action and associated time and/or date for the performance of the action. As illustrated in FIG. 20, user interface 2000's digest 2002 may include events performed by transporters (e.g., leaving starting location, arriving at pickup location, departing pickup location, arriving at tender location, and completing tender) and/or handlers (e.g., uploading tender documents, changing follow-up time, and changing delivery address). SOP 1824 may be provided handlers and/or users. As such, notes 1820 and/or SOP 1824 may be provided and performed by different handlers.

Various embodiments may be implemented, for example, using one or more well-known computer systems. One or more computer systems may be used, for example, to implement any of the embodiments discussed herein, as well as combinations and sub-combinations thereof.

Based on the teachings contained in this disclosure, it will be apparent to persons skilled in the relevant art(s) how to make and use embodiments of this disclosure using data processing devices, computer systems and/or computer architectures. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are potential, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc., using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

What is claimed is:

1. A system, comprising:
a memory; and
a processor in communication with the memory and configured to:
receive an electronic user request for transporting a good from a pickup location to a destination location;
locate, within a pre-generated graph data structure, a pickup node representing the pickup location, and a destination node representing the destination location;
locate, within the pre-generated data structure, a plurality of service carriers that service areas along a route from the pickup location to the destination location, wherein each of the service carriers have a corresponding service carrier classification requirement;
locate, within the pre-generated graph data structure, a first intermediate node representing a first intermediate location, and a second intermediate node representing a second intermediate location by traversing the pre-generated graph based on the pickup node and the destination node;
generate a classification of the good for each service carrier at each intermediate node, wherein the classification of the good is based on specifications of the good and a service carrier's classification requirements;
determine a plurality of transportation edges each having a transit cost and a transportation time that both correspond to the classification of the good, wherein the plurality of transportation edges each correspond to one of the pickup location, the first intermediate location, the second intermediate location, and the destination location;
determine, using a location and time-based machine-learning model, a tendering edge corresponding to the first intermediate node and the classification of the good, the tendering edge relating to an actual tender time to move the good from a first service carrier that has arrived at the first intermediate location to a tender location of the first intermediate location;
determine, using a cargo database, a cargo edge corresponding to the first intermediate node and the classification of the good, the cargo edge relating to a time for loading the good onto a second service carrier upon receipt of the good at the first intermediate location;
generate a subgraph of the pre-generated graph comprising the pickup node, the first intermediate node, the second intermediate node, the destination node, the tendering edge, the cargo edge, the classification of the good with the first carrier, the classification of the good with the second carrier, and the plurality of transportation edges;
generate a plurality of potential routes along the subgraph from the pickup location to each intermediate location and then to the destination location;
identify a route quote for each of the plurality of potential routes, wherein each route quote includes a total shipment time and a total cost estimate;
generate, using the subgraph, a preferred route from the pickup location to the destination location;
authorize the preferred route based on the classification of the good and the classification requirements of one or more selected carriers from the plurality of service carriers of the preferred route; and
update a user interface to display the preferred route and the route quote.

2. The system of claim 1, wherein the processor is further configured to:
retrieve service carrier information from one or more databases, wherein the service carrier information relates to the service carrier's classification requirements and includes classification options, size requirements, weight requirements, tender times, recovery times, tender hours, recovery hours, general hours of operation, special operation hour, holiday schedules, geographical information relating to the pickup location, geographical information relating to the destination location, historical data of transit costs.

3. The system of claim 2, wherein generating the classification of the good includes the process of:
identifying the plurality of service carriers at each intermediate node;
comparing each service carriers' classification requirements to specifications of the good; and
determining which classification the good satisfies for each of the plurality of service carriers at each intermediate node, wherein the specifications of the good include the size of the good, the weight of the good, the maximum dimension of the good, and the commodity of the good.

4. The system of claim 3, wherein the classification of the good is selected from the group consisting of small parcel, bulk loading, and container loading.

5. The system of claim 1, wherein the preferred route is selected from one of the following categories, lowest route quote for transporting the good, lowest shipment time, and a user preferred route.

6. The system of claim 1, wherein the total cost estimate is the aggregate of the transit cost for each transportation edge along the potential routes.

7. The system of claim 1, wherein the total shipment time is the aggregate of the times related to the transportation edge, tender edge, and cargo edge.

8. The system of claim 6, further comprising: determine, based on the classification and specification of the good whether the good can be consolidated with a second good that is traveling to the same first intermediary location, second intermediary location, or destination location.

9. The system of claim 8, wherein the transit cost is reduced if the good can be consolidated during the preferred route.

10. The system of claim 1, wherein the preferred route utilizes more than one mode of transportation.

11. The system of claim 1, wherein the preferred route utilizes more than one service carrier.

12. A computer-implemented method for generating a route quote for the transportation of a good, comprising:
receiving, by one or more processors, a user request for the transporting of the good from a pickup location to a destination location;
locating, by the one or more processors and within a pre-generated graph data structure, a pickup node representing the pickup location and a destination node representing the destination location;
locating, with the pre-graphed data structure, a plurality of service carriers that service areas along a route from the pickup location to a first intermediate node representing a first intermediate location, to a second intermediate node representing a second intermediate location, to the destination location;
determining, by one or more processors, a classification of the good at each of the pickup location, first intermediate location, second intermediate location, and destination location for one or more of the service carriers, wherein the classification of the good is based on specifications of the good and a service carrier's classification requirements;
determining, by the one or more processors, a plurality of transportation edges that each relate to a transit cost and transportation time associated with a corresponding one of the pickup location, the first intermediate location, the second intermediate location, and the destination location;
determining, by the one or more processors and using a location time machine-learning model, a tendering edge corresponding to the first intermediate node and the classification of the good, the tendering edge relating to an actual tender time to move the good from a first service carrier that has arrived at the first intermediate location to a tender location of the first intermediate location;
determining, by the one or more processor and using a cargo database, a cargo edge corresponding to the first intermediate node and the classification of the good, the cargo edge relating to a time for loading the good onto a second service carrier upon receipt of the good at the first intermediate location;
authenticating the classification of the good with the classification requirements of the first service carrier and the second service carrier;
generating, by the one or more processors, a subgraph of the pre-generated graph data structure comprising the pickup node, the first intermediate node, the second intermediate node, the destination node, the tendering edge, the cargo edge, the plurality of transportation edges, the classification of the good with the first service carrier, and the classification of the good with the second service carrier;
generate a plurality of potential routes along the subgraph from the pickup location to each intermediate location and then to the destination location;
identify a route quote for each of the plurality of potential routes, wherein each route quote includes a total shipment time and a total cost estimate;
generate, using the subgraph, a preferred route from the pickup location to the destination location;
authorize the preferred route based on the classification of the good and the classification requirements of one or more selected service carriers from the plurality of service carriers of the preferred route; and
display the preferred route and the route quote.

13. The computer-implemented method of claim 12, further comprising:
retrieving service carrier information from one or more databases, wherein the service carrier information relates to the service carrier's classification requirements and includes classification options, size requirements, weight requirements, tender times, recovery hours, hours of operation, special operation hour, holiday schedules, geographical information relating to the pickup location, geographical information relating to the destination location, historical data of transit costs.

14. The computer-implemented method of claim 13, wherein determining the classification of the good includes the process of:
identifying the plurality of service carriers at each intermediate node;
comparing each service carriers' classification requirements to specifications of the good; and
determining which classification the good satisfies for each of the plurality of service carriers at each intermediate node, wherein the specifications of the good include the size of the good, the weight of the good, the maximum dimension of the good.

15. The computer-implemented method of claim 14, further comprising: determining, based on the classification and specification of the good whether the good can be consolidated with a second good that is traveling to a common first intermediary location, second intermediary location, or destination location.

16. A computer-implemented method for consolidating the transportation of a plurality of individual goods, comprising:
receiving, by one or more processors, a plurality of user requests for the transporting of goods from a plurality of pickup locations to a plurality of destination location;
locating, by the one or more processors and within a pre-generated graph data structure, a plurality of pickup nodes representing the pickup location and a plurality of destination nodes representing the destination location;
locating, with the pre-graphed data structure, a plurality of service carriers that service areas along a route from the pickup location to a first intermediate node representing a first intermediate location, to a second intermediate node representing a second intermediate location, to the destination location;
locating, by one or more processors and within a pre-generated graph data structure, a common pickup location, intermediate location, or destination location between one or more of the user requests;
determining, by one or more processors, if one or more of the goods from the plurality of user requests can be combined into a containment shipment, wherein the determination of the containment of the goods of multiple user requests depends on the size, maximum dimension, weight, and required delivery time of each of the goods;
generating, by one or more processors, a preferred containment route for each of the user requests, wherein the preferred containment route for each of the user requests includes a common transportation segment from one or more of the pickup locations, intermediate locations, or destination locations between the user requests;
generating, by one or more processors, a preferred individual route for each of the user requests, wherein the preferred individual route for each of the user requests includes a transportation segment to transport the goods to the common transportation segment for the preferred containment route; and
generating, using the preferred containment route and the preferred individual route, a preferred total route from the pickup location to the destination location for each user request.

17. The computer-implemented method of claim 15, further comprising:
determining, by one or more processors, a classification of each of the goods at each of the pickup locations, first intermediate locations, second intermediate locations, and destination locations for one or more of the service carriers, wherein the classification of the goods are based on the dimensions and weight of the good and a service carrier's classification requirements;
authenticate the preferred individual route for each of the user requests based on the classification of each of the goods of the user request with the service carriers' classification requirements;
determining, by one or more processors, a classification of the containment shipment of one or more of the goods of one or more user requests at each of the pickup locations, first intermediate locations, second intermediate locations, and destination locations for one or more of the service carriers, wherein the classification of the containment shipment is based on the dimensions and weight of the containment shipment and a service carrier's classification requirements; and
authenticate the preferred containment route for each of the user requests based on the classification of the containment shipment with the service carriers' classification requirements.

18. The computer-implemented method of claim 15, further comprising:
generating a route quote for each of the user requests, wherein each route quote includes a total shipment time and a total cost estimate.

19. The computer-implemented method of claim 17, further comprising:
generating a transportation edge, relating to a transit cost and a transport time from each of the pickup location, intermediate location, and destination location;
generating a tender edge relating to an actual tender time to move the good from a first service carrier that has arrived at the first intermediate location to a tender location of the first intermediate location; and
generating a cargo edge relating to a time for loading the good onto a second service carrier upon receipt of the good at the first intermediate location, wherein the total shipment time is the aggregate of the transportation edge, tender edge, and cargo edge.

20. The computer-implemented method of claim 17, wherein the total cost estimate is the aggregate of the transit costs for each transportation edge along the preferred total routes.
